(19) United States
(12) Patent Application Publication
(10) Pub. No.: US 2006/0206873 A1
(43) Pub. Date: Sep. 14, 2006

(54) Environment for run control of computer programs

(76) Inventor: Pramod V. Argade, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/375,494

(22) Filed: Mar. 13, 2006

Related U.S. Application Data
(60) Provisional application No. 60/661,059, filed on Mar. 11, 2005.

(51) Int. Cl. G06F 9/44

(52) U.S. Cl. 717/135

(57) ABSTRACT

A method for modifying a user program and running it under the control of another program is provided. This provides ability to save states during the operation of a program in a loop and ability to jump instantaneously between them, either forward or backward in execution time. The invention also provides a way to optionally attach a debugger to an active state and to maintain debug context for all the saved states. The invention provides a means to run a computer program in virtual time machine, in galloping mode and in a safe mode.

### REFERENCE TO PRIORITY DOCUMENT

This application claims the benefit of priority of co-pending U.S. Provisional Patent Application Ser. No. 60/661,059 entitled “ENVIRONMENT FOR RUNNING AND DEBUGGING COMPUTER PROGRAMS”, by Pramod V. Argade, filed Mar. 11, 2005. Priority of the filing date of Mar. 11, 2005 is hereby claimed, and the disclosure of the Provisional Patent Application is hereby incorporated by reference.

### BACKGROUND OF THE INVENTION

1. Field of the Invention

The present invention relates to computer processor operation and, more particularly, to software execution in run-time environments with multiple timelines.

2. Description of the Related Art

A computer program is a collection of program statements, or instructions, that are executed by a processor of a computer system. The computer program is executed within an operating system (OS) program environment that is maintained by the computer processor. The OS is also a collection of program instructions and typically provides an interface between the electrical and mechanical (hardware) components of the computer system and the computer program. As the computer program executes, the computer system is said to be “running” the program. An executing program, or a program that is running, is also referred to as a computer process. There are many conditions under which it would be advantageous to have greater run-time control of program execution.

Physical Systems Simulation

Engineering and scientific problems of physical systems are often solved with the aid of computer programs that simulate a physical condition under study. The physical condition being studied can comprise, for example, electronic system design, building construction, medical device performance, vehicle dynamics, molecular interaction, meteorological simulation for weather forecasting, and the like. The computer simulation creates an artificial environment with virtual embodiments of the physical condition under study and permits adjusting parameters such as temperature, construction of components, mechanical and electrical forces, and the like. Each time the simulation program is run, physical parameters of the physical condition are taken into account and a simulation result is produced for observation. For example, building integrity in an earthquake can be observed, or medical device performance when implanted in a body can be observed, and so forth. With repeated simulation runs, parameters can be adjusted and the simulated result of the adjustment can be observed.

Unfortunately, it can be rather laborious to change simulation parameters and repeatedly execute the simulation computer program to observe the result of the changes. During engineering and technical development, it is often necessary to run thousands of simulation iterations, to carefully document parameter changes study the simulation results. Many runs of the simulation are required,-consuming much development time.

Physical systems simulation programs take significant amounts of time for their execution on the available computer hardware, with the execution time in the range of minutes to weeks. Such programs are run multiple times although the execution of initial portions of many such programs may be exactly identical. Typically, multiple computer systems are used to reduce the total calendar time required for the multiple runs. Currently, there is no simple way for a program to share common portions of execution across multiple runs. If common execution portions could be shared across runs, overall execution time could be reduced. This would permit reduction of overall execution time by executing the common portions only once.

Interactive simulation programs permit greater time efficiency, because simulation parameters can be changed on-the-fly and results can be observed, as the program executes. Nevertheless, greater fidelity in the run-time control of the interactive simulation program could permit more precise observation of the simulation results. For example, smaller time slices in observing program outputs might be possible, to better observe the result of parameter changes and to backtrack from observed output.

Social Systems Simulation

Computer programs are also used to simulate social systems, such as war games scenarios, disease propagation in a society, employment statistics for a national economy, and the like. Social system simulations permit observation of results for which it is impractical or even impossible to set up in the real world. Moreover, simulation time is greatly reduced as compared with the time for the actual situation to resolve itself. As with the simulation of physical systems, the computer programs for social system simulation are run many times over, with different parameter settings, for observation of results and study. Also as with physical simulations, greater run-time control over the execution of the program could provide improved opportunity to study the effects of parameter changes on the simulation results and could increase the efficiency of conducting multiple simulation runs.

Gaming Scenarios

Computer gaming is a multi-billion dollar industry. Game players engage in fierce competition, both within the virtual world of particular computer games and also among other players, for greater scores and superior game results. Within the game virtual world, a game player may confront opponents controlled by the host computer system. Results are often manifested in game scores or progress through virtual realms or scenarios. Obtaining better scores and achieving faster progress and attaining superior levels of play requires careful observation of actions and consequences within the game environment. Many repeated iterations of game playing are generally required for a player to acquire the skill set necessary to become masterful at playing a particular game.

During a game playing session, a game player repeatedly has opportunity for a stimulus-response association that is created by the game program. That is, a control input into the game virtual world results in an immediate consequence, in terms of a game score or game progress. At any moment during game play, a control input can often result in immediate (and unsuccessful) termination of the game session. Thus, a player's careful progression through a lengthy game session that required many prior iterations to achieve, may come to a sudden end. Another lengthy game session can be required to get back to the same point in the game, whereupon a different tactic or control input can be tried and observed.

Greater run-time control of a game program could enable a game player to save states and study successful and unsuccessful game strategies and tactics. This would drastically reduce the game session time required to master a game and would improve the level of mastery that could be achieved. For example, time iteration control over game execution could permit a game player to more carefully observe in-game responses to control inputs. Game sequence control would make it easier to backtrack from outcomes or preview planned inputs. Preservation of game states could assist in documentation and results authentication.

Computer Program Development and Debugging

Computer software development is a very large industry and it is estimated that as of the year 2004 there were about 1.5 million software developers around the world. Computer program development consists of three major steps. First, the program architecture is formulated which identifies various components of the program and how they relate to each other. The second step is the coding of the program in one or more suitable languages. The third step is verifying that the computer program works, as intended, and free of defects, in the given application.

A program may be run only a few times by a few users or numerous times by millions of users. A major challenge in software design is to ensure that the program will operate flawlessly under all the operating conditions. Any flaw in the program is referred to as a “bug.” A significant portion of software program development is devoted to finding and fixing bugs. Many tools are available in the market for software development. However, the debug process requires investigating program behavior back in time relative to the manifestation of the bug. There are no conventional tools to facilitate this.

Fault Tolerance

Although computer technology is quite mature, applications routinely crash in the middle of execution and work done up to that time is lost. It is desirable to recover from such a crash with minimal loss of effort/valuable data.

There are other scenarios, such as, playing a computer game, where the user may want to explore running the program in multiple ways. For example, the user may want to save the state of the game at certain point and return to it later and continue program execution using either the same or different input(s).

Computers are ubiquitous and have found numerous applications in diverse fields. However there are four major problems with state-of-the-art software running on state-of-the-art computer hardware. First problem is that if a computer program crashes, due to software bug(s), there is no recovery mechanism in most cases. In such a case, valuable data and or time invested in running the program is lost and the complete program has to be rerun in order to find and fix the problem. Second problem relates to software development process where finding and fixing “bugs” or errors in the programs is difficult and time-consuming process. Third problem is that if a program crashes intermittently, there is no easy mechanism to capture the entire stimulus that led to a particular crash. Finally, fourth problems is that even through many executions of a program may have exactly the same initial portions, there is currently no way of sharing this common portion of their execution to reduce overall program execution time. These and other problems with prior art way of running computer programs are discussed in detail below.

A computer program is typically written in a high level language and/or assembly language. A program may be comprised of from a few lines of code to millions of lines of code. It may be contained in a single module/function, contained in a single file or in multiple modules contained in one or more files. Most programs have similar basic structure. A typical program starts by processing command-line arguments or some configuration arguments contained in a file. This is followed by the program optionally opening one or more files from which it will read input and to which it will write output. It may also open one or more temporary file(s) for saving intermediate results of the program. Rest of the operation of the program typically is carried out in one or more loops by repetitively processing instructions contained within the loops.

A typical computer programs has one or more loops, code within which is repeatedly executed. For example a computer program that simulates timing behavior of a system typically has a loop that repeatedly executes code that simulates one incremental time step.

For example, a program that simulates a model of an integrated circuit chip (IC), written in a Hardware Description Language (HDL), such as Verilog or VHDL, is executed under the control of a HDL simulator program by repetitively processing operation of the microprocessor for one simulated clock cycle of the IC. Another example of a computer program is a word processor program, which executes in a cycle to process, in a loop, user input comprised of either a keyboard stroke and/or a mouse click. There may be other situations, such as, computation of certain value in a loop, where cycle would only mean another iteration through the loop. In the following discussion, we will use the terms iteration, cycle, and tick interchangeably.

A program is converted by a compiler into assembly code, which in turn is converted by a linker to the machine code (or “executable”) for a particular computer. A program runs on a computer under the control of an operating system (OS), which manages computer resources, such as, time slice to run the program, memory, storage, etc., and security of various computer resources. An instance of a program running on a computer under the control of an OS is called a process. When a program is run, OS creates the process by creating associated data structures to manage the required resources. It then loads the initial part of the program executable from secondary storage into the primary memory and starts executing the program.

Execution time for scientific and engineering applications is typically in the range of minutes to weeks. Many enhancements in computer hardware have continually been made to reduce the execution time of a program. On the other hand, the complexity of programs has also been increasing, which in turn requires more time to execute the programs.

Execution of a program consists of a sequential process of executing instructions by the CPU. A typical program includes arithmetic instructions, conditional instructions, as well as control transfer instructions (branch, jump, and subroutine call) that are executed as conditions warrant, and possibly in response to user input. It is almost impossible to determine the path taken by the program to get to a certain point in execution, because the instructions followed to get to the point are not known. Consequently, it is almost impossible to run the program backward, since it is almost impossible to ascertain all the instruction side effects that will have to be undone. The only practical solution is to save all the side effects of every instruction. The “Omniscient Debugging” technique uses this approach (e.g. see information at the URL of www.lambdaacs.com/debugger/debugger.html), which requires a large amount of data storage and considerably slows down the program execution speed.

There is no current methodology that guarantees that a given software program will be bug free under all the operating conditions. In fact, commercial software licenses typically explicitly state this fact as a disclaimer. Software programs routinely crash and valuable data as well as the investment in time and resources in running them are lost.

Software development, in general, takes a lot of engineering effort. A major portion of this effort is spent on ensuring that the software functions correctly under operating conditions and that there are no bugs. Finding the cause of a bug is typically a tedious process. A bug in software is an error on the part of the programmer in coding. An example of a bug is an error in a formula used to evaluate a certain expression. When a portion of the code with a bug is executed, the consequence(s) of the bug is (are) typically not immediately apparent. The bug, in general, may set in motion a domino effect, which eventually may result in either the program crashing (e.g. “segmentation fault”) or the program outputting incorrect value(s). Debugging involves a process of examining program output and working backward from the apparent consequence(s) and finding which statement(s) in the software contain the error(s). Since a computer program cannot be run backwards, the debugging process typically requires the software engineer to run the program multiple times in order to locate the code section with the error and then determine the needed correction.

Software defects are measured in defects per 1,000 Lines Of Code (defects per KLOC) and reported numbers are ˜6 defects per KLOC (see e.g. www.sei.cmu.edu/news-at-sei/columns/watts_new/1999/March/watts-mar99.htm). Since it is not unusual for commercially available software to include 10,000 lines to millions of lines of code, it can be appreciated that software debug process is extremely labor intensive.

Many debuggers are currently available, either free or for purchase. Examples are GDB (www.gnu.org/software/gnu) and Data Display Debugger (DDD, www.gnu.org/software/ddd). These debuggers generally provide a rich set of features to debug a program, such as, setting breakpoint/watch points, single stepping the program, etc. However, debuggers do not enable exploring the program state back in time. As a result, the software engineer still must manually run the program multiple times until the error is found and fixed.

In a typical debugger usage scenario, an application program is run each time with a different set of inputs. In this case, there is a class of bugs, which is particularly challenging to debug. These bugs are manifested only intermittently because their effects are propagated to certain point within the program only for certain set of input parameters. To debug this class of bugs, it is essential to recreate laboriously the conditions that lead to manifestation of the bug. State-of-the-art debug tools do not provide any facilities to address this problem.

It is possible, in principle, to dump complete internal state of a program to a file at a specified point in execution. The application could then be restarted at the same point in execution by reloading the state. This process is called checkpointing, and is implemented in some programs, including some computer games. However, it is very hard to implement such a feature in a general program.

Recently, a company named VirtueTech (www.virtutech.com) has introduced a product, called Simics Hindsight, that enables running computer simulation in reverse. In order to use the tool offered by this company, special models of the processor have to be built. This company offers such models for some of the most commonly used processors in embedded applications. Furthermore, for models of the blocks not available from Virtutech have to be written so that they conform to the Application Programming Interface (API) specified by the company. When hardware is modeled according to the specifications from this company, the computer programs running on the model can be run in reverse.

Another company, named Green Hills Software, Inc. (www.ghs.com), has introduced a product that captures run-time trace from an embedded system. Such trace is gathered from a processor chip that has a JTAG or other debug port. This port sends information while running the program, such as, the program counter, which registers/memory location changed as well as its new values of variables etc. to the outside world. Trace collection hardware captures up to 1 gigabytes of run-time trace representing a few seconds of real execution time on the embedded system. The company offers a tool that post-processes this trace and provides ability to go back in time and reconstruct the steps taken by the program during execution. The trace data is coupled with the source code to help debug the programs.

A product from a company named Meiosys (www.meiosys.com) offers a product, “MetaCluster” which enables saving complete state-of a process in a file and continuing the same process at a later time by reloading the state from the file. MetaCluster product runs on a version of Linux, where the kernel has been modified by Meiosys to capture and restart the state of a process. Use of such a tool is appropriate for fault tolerant computing, where an application can be restarted if the computer hardware crashes.

A large number of computer programs are run multiple times with different set of stimuli. For example, a program that simulates the real-time behavior of an integrated circuit is run using a large number of tests, some of which have common portions. For example, one program test run may involve part “A” followed by part “B” and another test run may involve part “A” followed by part “C.” There is no currently known way for the two test runs to share running of part “A,” which would thereby reduce the overall time it takes for the two program runs.

A program interacts with an OS by making a “system call” and providing the required arguments. (For a description and usage of system calls, see, for example, “Beginning Linux Programming” 2^{nd} Edition, Authors Richard Stones and Neil Matthew, Wiley Publishing, Inc., Copyright 2003. ISBN 0-7645-4373-3, Chapters 3, 10, 12). For example, Linux (http://www.linux.org) and Unix (http://freebsd.org) operating systems provide system calls. These systems calls support operations, such as, to spawn a child process (“fork”), execute a program image in a process (“exec”), open communication pipes between processes (“pipe”), read/write from a file or pipe (“read” and “write”) and send a signal to a process (“kill”).

On Linux or Unix operating systems, a “fork” system call creates a child process which is an identical copy of the parent process that executed the fork. The return value of the “fork” system call enables a resulting process to determine whether it is a parent or a child process. The parent process could be arranged to wait (using “wait” system call) for the child process to die. Thus, the program could proceed in the child process, whereas the parent is “frozen” at a particular point in execution. When the child process exits, the “wait” system call returns in the parent process and the execution can continue there. Thus, this mechanism provides a limited way for the program to go back in time to the immediate parent process. However, this mechanism does not provide the ability to jump between saved execution points within the program. In particular, a process saved earlier in time cannot be made aware of the one or more processes later in time.

It is noted that Linux and Unix operating systems have an efficient implementation of a fork system call which implements “copy on write” (see URL en.wikipedia.org/wiki/Copy-on-write) while replicating resources from the parent process to the child process. The fundamental idea behind it is that if multiple processes ask for resources, which are initially indistinguishable, you can give them pointers to the same resource. This fiction can be maintained until a process tries to modify its “copy” of the resource, at which point a true private copy is created to prevent the changes becoming visible to everyone else. All of this happens transparently to the processes. The primary advantage is that if a process never makes any modifications, no private copy need ever be created.

Furthermore, note that when a fork system call is executed, the spawned child process inherits all the file descriptors, including all the pipes that may be opened by the parent process.

It must be emphasized that the portion of the code that has the bug and the portion of the code where the bug is manifested are typically in different portions of the code. As a consequence, the debug breakpoint and watch points used by the software engineer are in general different in different portions of the code.

It view of the foregoing discussion, it should be apparent that disadvantages in the conventional manner of running computer programs creates a need for improved run control techniques and tools. The present invention satisfies this need.

### SUMMARY

In accordance with the present invention, a computer system with a processor unit that executes program code, includes computer program code that is operatively stored in the computer system, and provides run-time control of the computer program execution, by executing simulation control program code from within an operating system of the computer apparatus for controlling execution of an interactive simulation program comprising the computer program code modified with at least one function call inserted in a loop code section of the computer program code, wherein a child process of the executing simulation control program code is in inter-process communication with the interactive simulation program and wherein the interactive simulation program interactively receives program execution commands from the simulation control program code, such that real-time execution control of the interactive simulation program is achieved with preservation of the computer program behavior. By “computer program behavior” is meant the way in which a computer program operates in terms of responses to any input requests and any output that is produced by the computer program. Thus, the program behavior of the modified computer program comprising the interactive simulation program is the same as that of the unmodified computer program, given the same inputs.

The resulting technique for executing the computer program provides a more convenient, powerful, and efficient computer process. In this way, the present invention provides a new environment for running a typical computer program. It provides a means to save intermediate states while running a computer program and ability to instantaneously jump from one saved to another saved state, both backward and forward. Each state is an independent instance of the program. The user may direct the progress of each state independent of all other states. Thus, each state is in an independent universe. In this way, a user can modify a computer program and run it under the control of a simulation control program. The modified program operates (produces output) as it would without the modification, so that the modification is transparent to the user and the computer program response is preserved. In the modified condition, the program is referred to as the interactive simulation program. This provides the ability to save states during the operation of a program in a loop and the ability to jump instantaneously between the states, either forward or backward. This technique for real-time run control of program execution has application to a wide variety of computer programs, including programs for physical systems simulation, social systems simulation, gaming scenarios, and computer program development and debugging.

In one aspect of the disclosed technique for execution of a computer program, a simulation function call to an initialization code section of the computer program is inserted into the computer program, and one or more cycle function calls to a loop code section of the program code are inserted, so that the computer program with inserted simulation function call and cycle function calls comprises an interactive simulation program that can be executed under control of a simulation control program in a child process that establishes inter-process communication with the simulation control program to interactively receive program execution commands that permit real-time execution control of the interactive simulation program while preserving the computer program response as it would be without the modification. In this way, run-time control over the execution of the computer program is achieved and a more flexible run-time environment is provided.

By using the technique of the present invention, in case of a program crash, one or more states prior to the crash are saved. In addition, present invention provides a method to maintain multiple debug contexts. While jumping from once saved state within a program to another, it provides a way to automatically save debug context associated with the old state and a way to attach saved debug context to the new state. The present invention also provides a way for multiple program runs to share initial common portions so as to reduce the overall execution time for all the programs combined. These and many other novel features of the present invention result in a new approach to running and debugging programs which is not anticipated, rendered obvious, suggested or even implied by any of the prior art ways of running and debugging computer programs, either alone or in any combination thereof.

There has thus been outlined features achieved with the invention in order that the detailed description thereof may be better understood, and in order that the present contribution to the art may be better appreciated. There are additional features in accordance with the invention that will be described hereafter. In this respect, before explaining embodiments of the invention in greater detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed here are for the purpose of the description and should not be regarded as limiting. These and other features and advantages of this invention are described in or are apparent from the following detailed description of the preferred embodiments.

### BRIEF DESCRIPTION OF THE DRAWINGS

Preferred embodiments of this invention will be described in detail, with references to the following figures, wherein:

FIG. 1 shows a typical computer system.

FIG. 2 shows a schematic of printed circuit board, also called motherboard, inside a typical computer system.

FIG. 3 shows conventional application program execution and example execution of a program using a control program according to the present invention.

FIG. 4 shows Graphical User Interface (GUI) for TMSim program built according to the present invention, which controls the execution of an application program.

FIG. 5 shows a typical program shown in Table 1 that is modified according to the present invention.

FIG. 6 shows the example program in Table 2 that is modified according to the present invention.

FIG. 7 shows pseudo code for “tmsim.cpp” module according to the present invention.

FIG. 8 shows pseudo code for “isim_init.cpp” module according to the present invention.

FIG. 9 shows pseudo code for “isim_cycle.cpp” module according to the present invention.

FIG. 10 shows ISim and TMSim interacting with each other via named pipes according to the present invention.

FIG. 11 shows pseudo code for “runloop.cpp” module in TMSim according to the present invention.

FIG. 12 shows pseudo code for “TMDbug.cpp” module according to the present invention.

FIG. 13 shows ISim, TMSim, TMDbg and a debugger interacting via named and unnamed pipes according to the present invention.

FIG. 14 shows an example list of commands implemented by TMSim according to the present invention.

FIG. 15 shows pseudo code for “isim_cycle.cpp” module that executes the save command according to the present invention.

FIG. 16 shows a typical execution of ISim under the control of TMSim in “galloping mode” according to the present invention.

FIG. 17 shows modifications to TMSim code to support interaction with multiple users.

### DETAILED DESCRIPTION

The present invention takes advantage of the fact that a typical computer program consists of initialization code and a major repetitive loop where most of the computation is done. The technique in accordance with this invention calls for making a predefined “isim_init” function call from the initialization code of the program under study for interactive simulation and calls for making a “isim_cycle” function call from the repetitive part of the program code. The resulting modified program is referred to here as “Interactive Simulation” (ISim) and is run under the control of another program referred to as “Time Machine Simulator” (TMSim). Another program, referred to as “Time Machine Debugger” (TMDbg) may also be run optionally to attach a debugger to ISim under the control of TMSim.

Instead of calling both functions isim_init from the initialization code and isim_cycle from the repetitive part of code, isim_cycle alone may be called from the repetitive part of the program code. In this case, function isim_cycle would keep a global variable, which would keep track of whether isim_cycle has been called for the first time. In the case of a first call to isim_cycle, the functionality in isim_init will be carried out. On second and subsequent calls to isim_cycle, isim_init will not be carried out. Although this gives similar functionality to calling both functions, this technique loses fine control over the program in the initialization portion of the code, particularly when a debugger is attached.

The modified computer program, ISim, is executed in a child process by TMSim, which establishes communication with ISim by opening inter-process communication with it. TMSim sends program execution commands, such as spawn state, pause state, wake up state, and the like, to isim_cycle, which executes them. Since isim_cycle is called during every iteration of ISim, the user gains single iteration level control over running ISim. TMSim also optionally runs TMDbg and establishes inter-process communication with it. TMDbg in turn runs a debugger specified by the user, which attaches with ISim. In this way, the user has iteration level control over running ISim, while simultaneously, ISim can be run under the control of the debugger.

TMSim provides a rich set of commands for controlling the execution of ISim, such as spawning a state, by forking a child process, jumping instantaneously between saved states by pausing and running processes, and the like. Because of the latter ability, parallel universes are created in which each spawned state runs an instance of the program. Since TMSim provides the ability to jump instantaneously between states, this jumping creates an illusion of a time machine for running computer programs. We thus also refer to TMSim as Virtual Time Machine (VTM), as well as Parallel Universe Run-time Environment (PURE).

The original programs under study can be written in almost any computer language and can be interfaced to TMSim according to the present invention. Similarly, the mechanism for running ISim together with TMSim and optionally TMDbg can be implemented on any operating system that provides system calls for facilities, such as inter-process communication and spawning child process, either native or via special library.

The present invention provides a radically new way of running computer programs. The ability to spawn multiple states and jump almost instantaneously between them has numerous applications, including but not restricted to:
Make any program fault tolerant. If the program crashes, TMSim enables jump to a previously saved state of ISim, from which either the offending input could be saved or the work up to that point can be salvaged.
Enable a program “galloping mode” where the intermediate states are saved per specifications from the user while executing the program. These states can be used for multiple purposes, such as fault tolerance, debugging or for sharing portions of execution for multiple runs.
Save considerable time in the software debug process by providing ability to go back in time to inspect the program state. This obviates the need to rerun the program from the beginning.
Provide multiple debug contexts which can be automatically detached/attached when jumping from one state to another, thereby simplifying program debug process.
In case of intermittent bugs, this invention facilitates capturing input stimulus that leads to premature termination or aberrant behavior can be easily captured.
In case multiple program runs shared the same initial execution sequence, this invention provides a way to save the repeated wasting of valuable computer execution time by sharing initial portions of execution among multiple program runs that run identical code with identical input.
Re-run a program from selected point. E.g. restart a game from a previously reached point when the user is “killed” or wants to explore a different path in the game.

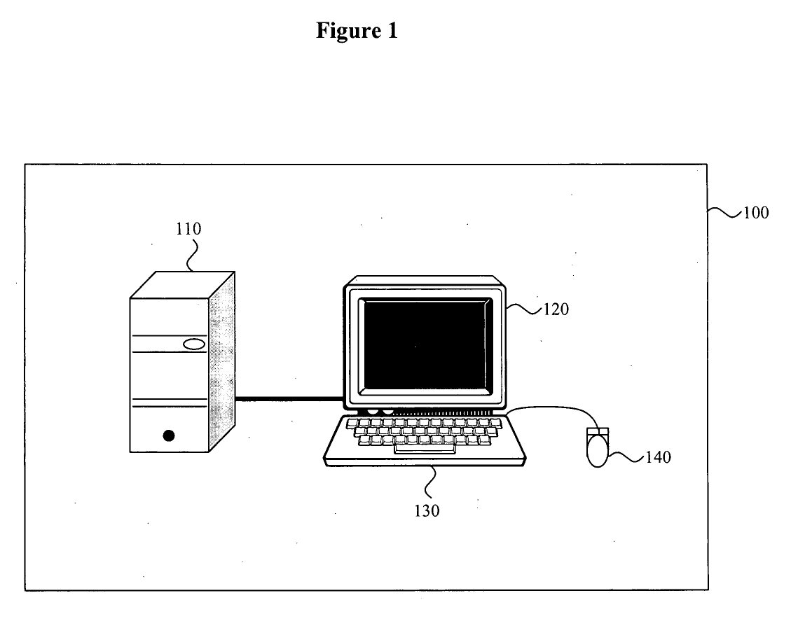

FIG. 1 shows a typical computer system (100). It consists of an enclosed box (110) that typically contains a printed circuit board populated with integrated circuits, power supply and peripherals, such as, Compact Disk (CD), Digital Video Disk (DVD), and connectors for peripherals, such as, Universal Serial Bus (USB) devices, keyboard (130), mouse (140), monitor (120) and printer (not shown).

The computer system 100 includes an Operating System (OS) program that controls the working of the computer system, including managing access to computer resources, receiving commands from the user and running application programs. Those skilled in the art will also appreciate that the computer system could be implemented as an embedded system, in which the computer controls the operation of a device, such as a control system in an automobile, with minimal, if any, interaction from the user. Such systems are increasingly making use of real-time OS in their operation.

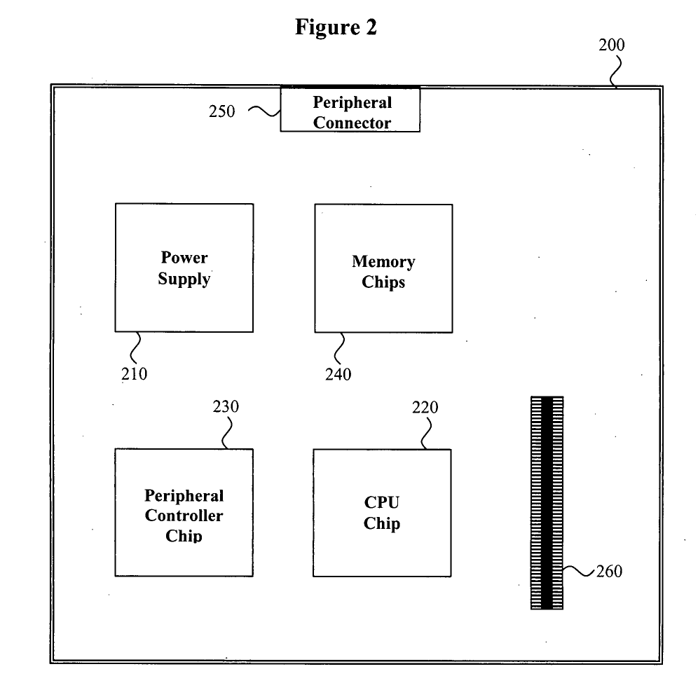

FIG. 2 shows a computer motherboard (200), which is a printed circuit board with multiple layers for interconnecting components mounted on the surface. Example components of the motherboard components in the system 100 include a CPU Chip (220), Peripheral Controller Chip (230), Power Supply (210), Memory Chips (240) and Peripheral Connector (250). The motherboard can also have one or more sockets (260) into which a daughter card is plugged in. Various chips on the motherboard contain logic required to run the OS as well as application programs.

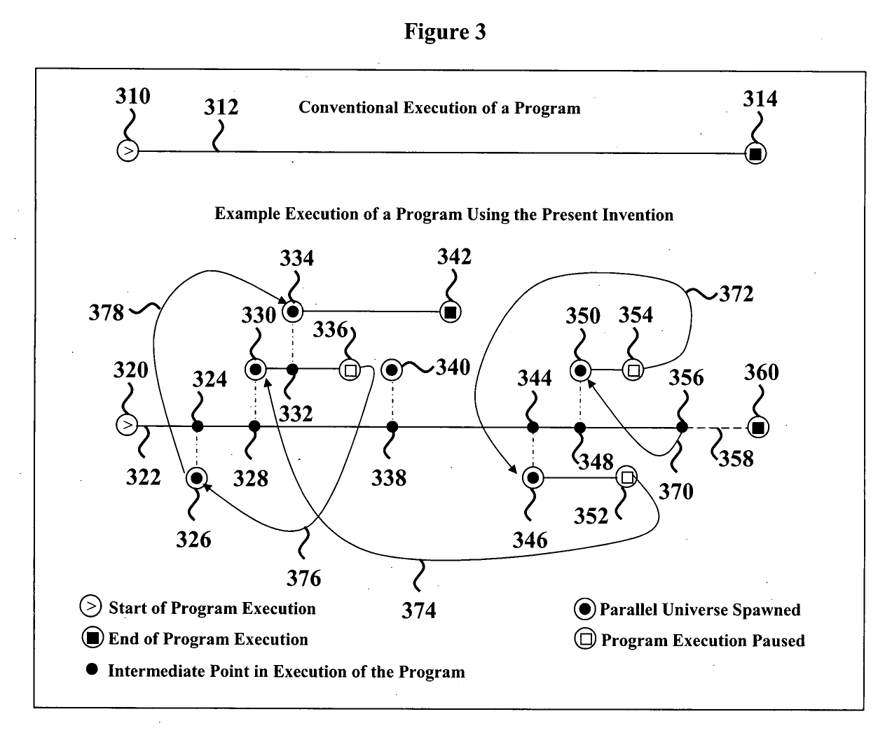

FIG. 3 contrasts conventional execution of a program with that using the present invention. A conventional application program starts execution (310) and continues execution for a certain amount of time represented by line segment 312 and ends (314). Once a conventional program execution is started, it can only proceed forward in time using only one set of input parameters, if any.

In accordance with the present invention, run-time control over an application program is obtained through a small modification in the code of the application program, as described further below. The resultant compiled application program is run under the control of a program we will refer to as control program, or TMSim. TMSim is installed in the computer 100 and is executed, whereupon TMSim is instructed to run the modified application program. TMSim starts execution of the application program (320), which proceeds forward in time, as represented by line segment 322. If run in a way similar to the conventional way, the program would end at 360. According to the present invention, User gains run-time control over the execution of application program via TMSim. For example, user can decide how long the program runs before taking the next course of action. Execution events 324, 328, 338, 344, 348 and 356 are example intermediate points within the application program execution, where the execution is halted temporarily. The intermediate point may be programmed in TMSim to be determined by temporal progress of the application program (i.e., subject to clock time) or based on an event in the application program, such as request for user input. Another example of an event is when a debugger is attached, in which the intermediate point may be when a breakpoint is reached.

At an intermediate point, the application program is paused and the user can specify a variety of commands to TMSim via a user interface. One of the commands is to spawn a Parallel Universe by creating an identical instance of the application program at that point in the program execution (i.e. fork a process). For example, FIG. 3 shows following pairs of (intermediate point, creation of identical instance): (324, 326), (328, 330), (338, 340), (344,346), (348, 350). Once an identical instance is created, such as 330 from 328, the user can control further execution of that instance by providing the same additional inputs as provided to advance the original process from point 328 to 338, or different inputs.

One of the other options to the user at an intermediate point, via TMSim, is to pause the current instance at that particular point in time and jump to another paused instance. This process of jumping takes very small amount of real time and seems almost instantaneous to the user. Furthermore, TMSim provides ability to jump to any paused state either forward or backward in time relative to the current state. This creates an illusion of a time machine and we also refer to TMSim as Virtual Time Machine (VTM). TMSim helps create an illusion to the user of creating multiple parallel universes on demand and jump at will between them. We thus refer to TMSim also as Parallel Universe Run-time Environment (PURE).

In the example execution using the present invention as illustrated in FIG. 3, after creating identical instances as described above, the user instructs TMSim to pause the application program execution at an intermediate point 356 and jump to the state paused at 350, conceptually shown via arrow 370. The user then instructs to advance this state to 356, pause it and jump to state 346, shown via arrow 372. This state is then instructed to advance to 352, pause it and jump to state 330, shown via arrow 374. This state is instructed to advance to 332 at which point an identical instance 334 is created and paused. State 223 is then instructed to advance to 336, pause and jump to state 326. The user decides not to advance this state further, but instead instructs TMSim to jump to state 334, shown via arrow 378. This state is advanced to 342, where the user decides to terminate program execution under the control of TMSim. Note that the user has not utilized state 340 in this run.

TMSim provides ability to jump either backward in time (for example from 352 to 330) or forward in time (for example from 326 to 334). The dotted line between a state (e.g 332) and a created identical state (e.g. 334) only indicates that the two states are identical in terms of temporal and functional state of program execution. Also, note that the user has the option of running the modified application program, we refer to as PURE-fied program, in conventional way, i.e. without the control of TMSim. Since the modification to the application program is minimal, such modified program run in the conventional way would run with a negligible degradation in execution speed and would be substantially transparent to the program user.

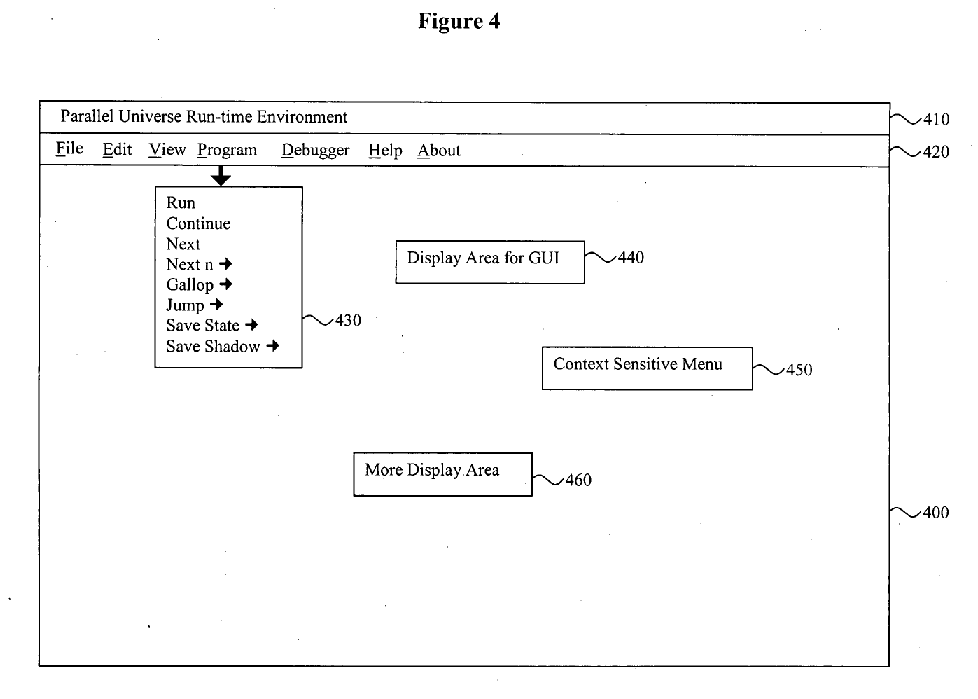

FIG. 4 shows a schematic representation (400) of a Graphical User Interface (GUI) of the control program TMSim that enables the user to control the operation of TMSim and thereby have run-time control of the application program. “Parallel Universe Run-Time Environment” (410) is an example brand name of this GUI program. The menu bar (420) of the TMSim GUI lists various menus available to the user to interact with TMSim. The first underlined character of the menu is typically used as a shortcut to get to the menu via keyboard keystrokes. Each one of the menus optionally has a submenu. One example of a submenu (430) for the “Program” menu item is shown in FIG. 4. The TMSim GUI may consist of one or more display areas (440, 460), the actual number of which is typically context dependent. Each one of the display areas may have a context sensitive menu which is activated when a mouse button is clicked or a particular sequence of keyboard keys is pressed in a particular display area. Submenu (430) shows example commands available to the user to run the interactive simulation application program according to the present invention. The “Run” command is used to start running the program. The “Continue” command is used to continue execution of the program to completion or until a breakpoint set in the debugger is hit. The “Next” command is used to run the program one iteration through loop. The “Next n” command runs the program “n” iterations through loop. An arrow next to a submenu item in 430 indicates that it has another level of submenu associated with it. Some of the remaining “Program” submenu commands will be explained further below, such as “Gallop,” “Jump” and “Save State”.

In order to describe the present invention as well as its example operation, we will use pseudo code for simplified examples of typical programs. Pseudo code is a shorthand way of describing a computer program. Rather than use the specific syntax of a computer language, more general wording is used. Using pseudo code, it is easier to understand the logic of the program. Where appropriate, we will mix pseudo code with c++ style program statements.

TABLE 1

| | |
|---|---|
| T101 | //typical.cpp: Pseudo-code for a typical program |
| T102 | // This program is written in C++ style code |
| T103 | #include <...> |
| T104 | int main( int argc, char* argv[ ] |
| T105 | { |

| | |
|---|---|
| T106 | int limit; |
| T107 | Program Initialization Code |
| T108 | for( int I = 0; I < limit; I++ ) |
| T109 | { |

| | |
|---|---|
| T110 | Body of the loop |

| | |
|---|---|
| T111 | } |

| | |
|---|---|
| T112 | } |

Table 1 shows pseudo code for a typical application program under study. Lines T101 and T102 are comments used to document the program and the compiler does not process them. Such comment lines are typically indented for explanation or for cosmetic reasons. Line T103 specifies name of files whose contents will be inserted in place of the include statement. There may be any number of such “include” directives. Line T104 signifies start of the “main” function within the program, along with return value type and the arguments and their types. This function is called when a program is executed by the OS. Line T105 signifies start of the body of “main” function and line T112 signifies its end. Line T106 defines a variable name, called “limit” and its type, which is an integer. Line T107 calls a function named “initialize” which may take zero or more arguments and performs program initialization such as outlined in the “Description of the Related Art” section above. The initialization may be performed using in-line code or via multiple initialization routines. Line T108 signifies beginning of a loop which will be executed for a number of iterations determined by the value of the “limit” variable. Lines T109 through T111 are the body of the loop.

TABLE 2

| | |
|---|---|
| T201 | //segfault.cpp: Example program that aborts |
| T202 | // Program sets every other element of a[ ] to 1 |
| T203 | // To compile: |
| T204 | // g++ −o seg_fault seg_fault.cpp |
| T205 | int main( int argc, char* argv[ ] |
| T206 | { |

| | |
|---|---|
| T207 | int* a = new int[ 5 ]; |
| T208 | for( int i = 0; i != 5; i += 2 ) |
| T209 | { |

| | |
|---|---|
| T210 | a[ I ] = 1; |

| | |
|---|---|
| T211 | } |

| | |
|---|---|
| T212 | } |

Table 2 shows an example of a program, which can be compiled and run on an operating system, such as, Linux or Unix. When run, this program aborts with a segmentation fault. Lines T201 through T203 are comments. Line T204 is also a comment, which gives a command recipe for compiling the program. Line T205 specifies beginning of the function “main” along with its arguments, whereas lines T206 and T212 signify the beginning and the end, respectively, of the function main. Line T207 specifies a variable named “a” of type integer and allocates a space to hold five such integers starting from address “a.” Lines T208, T209, T210 and T211 specify a loop, which will be repeated while i is not equal to five. At the end of every loop, i is incremented by two. Line T210 is the body of the loop. The implied intent of this program is to set value one every other element of array a[i], for i=0 to 4. The programmer made an error and set the limiting condition for the loop to be “i !=5” instead of “i<5.” As a result, the loop does not terminate because “i” never becomes equal to 5. The array “a” was assigned using operator “new” on line T207 to allocate only 5 elements and a[4] is the farthest element that should be accessed. Since the program loop continues to access elements beyond this point, the program eventually aborts with a “segmentation fault,” which means that program accessed memory that has not been assigned to it by the operating system.

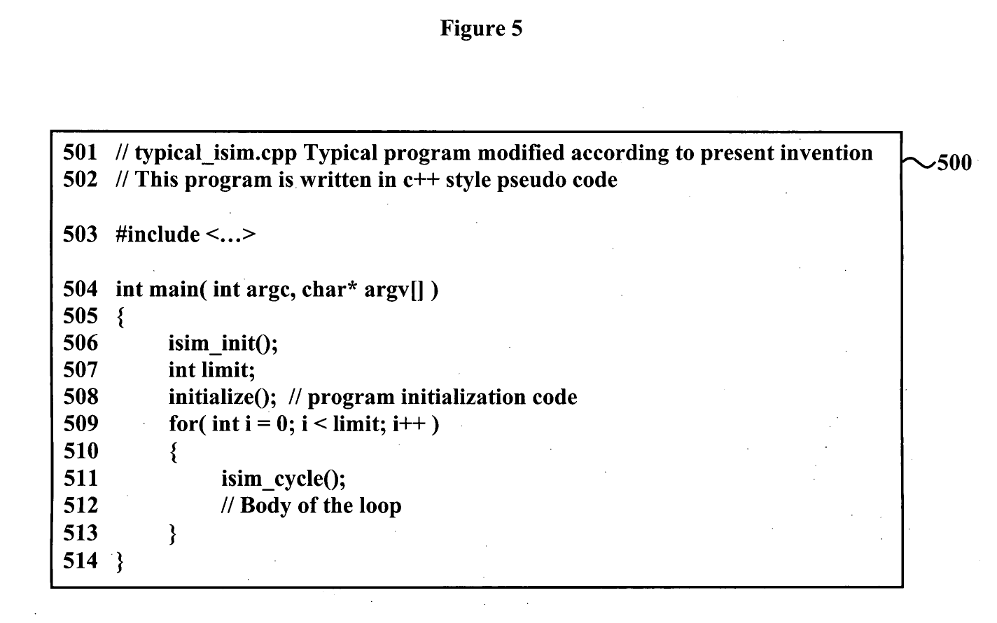

FIG. 5 shows pseudo code for a typical program 500 based on the code shown in Table 1. The program code 500 has been modified according to the present invention and is stored in the computer 100 (FIG. 1) for execution in accordance with the invention. The modification consists of inclusion of two statements numbered 506 and 511.

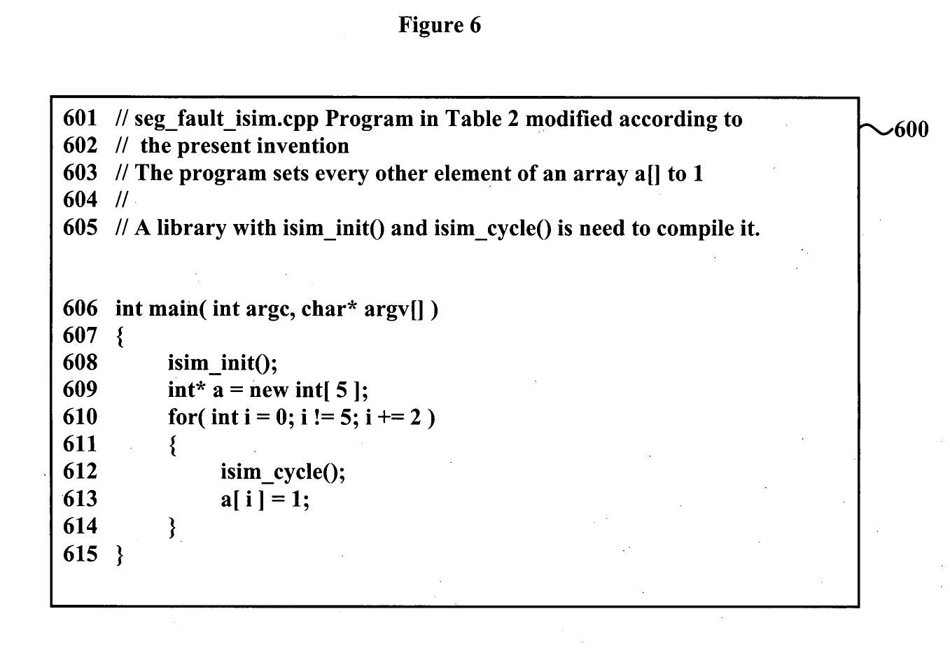

FIG. 6 shows program code 600 based on the code in Table 2, which as been modified according to the present invention. The modification consists of inclusion of two statements numbered 608 and 612, which are the same as additional statements 506 and 511 in FIG. 5. The implementation of functions isim_init and isim_cycle will be discussed below. In general the programs may or may not interact with the user at run time. Inclusion of functions isim_init and isim_cycle make the application program become interactive under the control of TMSim. We will refer to a program, such as in FIGS. 5 and 6, modified according to the present invention, as ISim (“interactive simulator”) or as a “modified program” and we will refer to an unmodified program, such as in Table 1 and Table 2, as “application program” or “user program” under study and control. Note that if the application program interacts with a user at run time, a corresponding ISim will also interact with the user in an identical way.

As has been pointed out before, a typical program consists of an initialization section and a loop section. As discussed above, in a general case, we refer to one iteration through the loop as one cycle. For a simulation, such as logic model of a microprocessor, the cycle may correspond to the simulated clock cycle of the microprocessor under study.

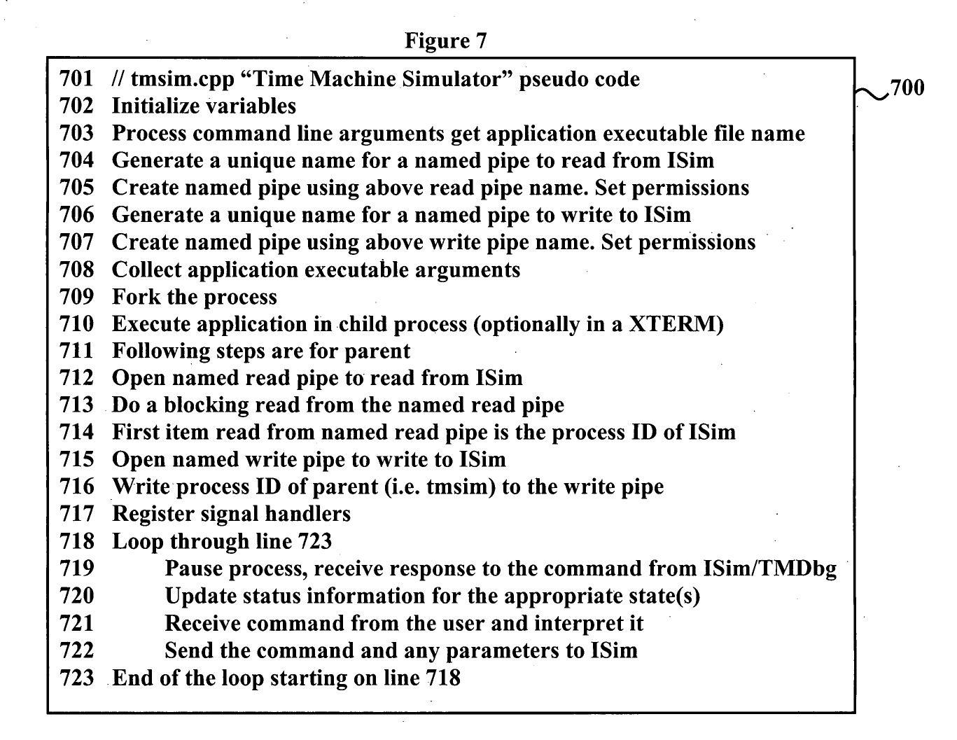

FIG. 7 shows pseudo code for a program (700) that controls the operation of ISim, both forward and backward. Hence we refer to the program in FIG. 7 as TMSim (“Time Machine Simulator”). The simulation control program code as illustrated in FIG. 7 is installed in the computer system 100 for execution. Note that one line of pseudo-code in the following figures may translate into one or more lines of actual code.

Line 701 is a comment. Line 702 initializes program variables. Line 703 processes the command line arguments. An example of command line argument is “-h” or “- -help,” which prints TMSim program usage. Another example of a command line argument is “-e isim_name” or “- -exec isim_name,” which specifies the name of the ISim executable to be run under the control of TMSim. According to one implementation of this invention, TMSim and ISim are separate programs and they communicate with each other using “named pipes,” although any other mechanisms used are covered by the present invention.

Note that inclusion of statements 608 and 612 in FIG. 6 is the only minimum modification to the user application under study and control according to the present invention. As a result, there is no way, at run time, to communicate names of the named pipes between TMSim and ISim. Hence, a convention for naming the named pipes may be used. One mechanism would be to use a fixed name, such as “/tmp/TMSimReadPipe” and “/tmp/TMSimWritePipe, for the read and write pipes respectively. A problem with such a scheme is that only one TMSim and ISim pair of programs could be run at any given time on a given computer, otherwise the same named pipes above will get used by multiple programs, leading to a conflict. To make this more flexible, the name of the pipe may contain the Process ID (PID) of TMSim. As will be discussed below, TMSim forks a child process in which it executes ISim. ISim can discover the PID of TMSim by using “getppid( )” function call.

This is one mechanism for ISim to discover the PID of TMSim. In this case, the names of the named pipes could be generated using the PID of TMSim. For example, if the PID of TMSim is 5479, example names of the read and writes named pipes are “/tmp/5479r” and “/tmp/5479w” respectively. Note that the named pipes are files, which behave as a “first-in-first-out (FIFO).” In this example, they are created in /tmp directory since temporary files in Linux and Unix are typically created in that directory.

Optionally, TMSim may fork a child process in which it executes XTERM which in turn runs ISim. In this case, both TMSim and ISim can discover the process ID of XTERM, which can be used to form the name of the named read and write pipes.

Lines 704 and 706 generate names of read and write named pipes respectively, using a mechanism, such as, one outlined above. Using these names, lines 705 and 707 generate the read and write named pipes respectively, for example by invoking “mkfifo( )” system call. We will refer to the pipe that ISim writes to and TMSim reads from as “ISimWritePipe” and the pipe that TMSim writes to and ISim reads from as “ISimReadPipe.”

According to one implementation of the present invention ISim and TMSim run simultaneously and interact with each other via named pipes. Furthermore, as will be discussed below, a program, called “Time Machine Debugger”, or “TMDbg”, that dynamically attaches or detaches a debugger to ISim may optionally be run in unison with ISim and TMSim. The user invokes TMSim and specifies the names of ISim and a debugger to run under the control of TMDbg, along with their respective options. Line 708 processes these command line arguments for TMSim. Note that, in general, three sets of command line arguments may be specified to TMSim. First, there are arguments for TMSim. Second, there may be arguments for user application, ISim, which may be preceded by “- -appargs.” Third, there may be arguments for TMDbg, which may be preceded by “- -dbgargs.” Line 708 selectively prepares the arguments for the application program, ISim.

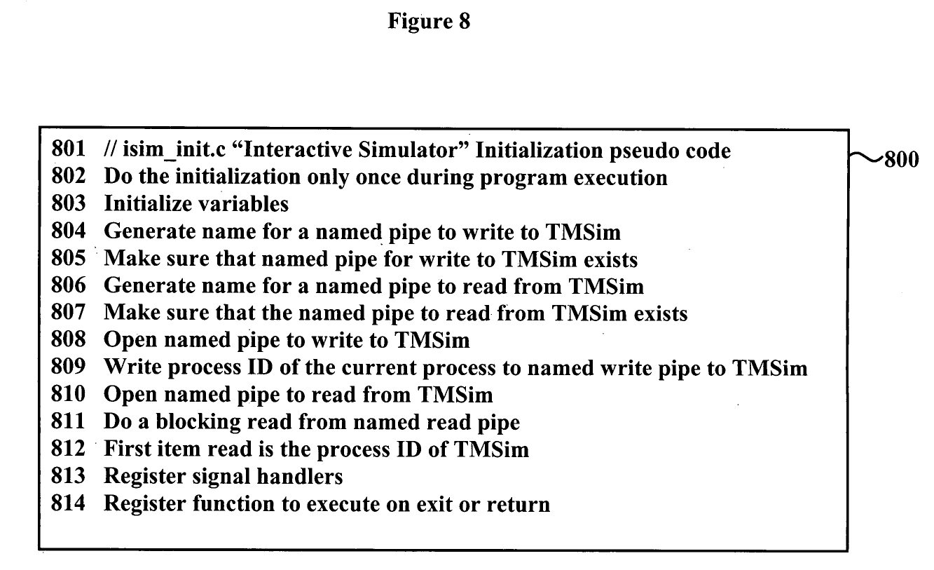

Line 709 forks a child process using “fork( )” system call. A return value of zero indicates the child process, a return value of minus one indicates error and return value greater than zero indicates the parent process. Line 710 is executed only in the child process and it executes ISim using, for example, execvp( ) system call. An example of arguments for execvp system call is:
Execvp(“xterm”, appArgv);
Where,
char** appArgv=“xterm -e seg_fault_isim arg1 arg2”

Where, seg_fault_isim (FIG. 6) is the name of ISim executable and arg1 and arg2 are two command line arguments to the executable seg_fault_isim. At this point seg_fault_isim starts running in a XTERM window. A motivation to execute ISim in a separate XTERM is so the terminal input and output for ISim and TMSim are in different windows and it is easier for the user to interact with them. Alternatively, TMSim may provide a separate XTERM for each ISim process. A graphical user interface application shown in FIG. 4 may integrate ISim, TMSim (and TMDbg to be explained below) into a unified view with separate or a single window for each component. The parent process executes statements below 711 only. After executing line 710, the child process starts executing the program in FIG. 8 as discussed below.

Line 712 opens the name pipe ISimWritePipe created in line 705 for reading. Line 713 does a blocking read from this read pipe. The parent process blocks on this read until the data becomes available when ISim process writes to the pipe as discussed below.

FIG. 8 shows pseudo code for function isim_init (800) which is run from ISim (see FIGS. 5 and 6). Line 801 is a comment. Line 802 sets up variables such that the initialization code in isim_init is executed only once. This is to guard against multiple calls to isim_init from ISim. Line 803 initializes program variables. Lines 804 and 806 generate names of the read and write named pipes ISimReadPipe and ISimWritePipe respectively using TMSim process ID discovery mechanism discussed above. Lines 805 and 807 ensure that the named pipes exist. Since TMSim (FIG. 7) opens these pipes before executing ISim in the child process this check for existence of pipes should always pass and is included as a precaution.

Line 808 opens the named write pipe ISimWritePipe and line 809 writes the process ID of the current process, i. e. ISim to the pipe. This write unblocks TMSim in FIG. 7 at line 713 and as indicated in line 714, the first item read from this pipe is the process ID of ISim. Line 810 opens the named pipe ISimReadPipe to read from TMSim. Line 811 does a blocking read from this read pipe. ISim process blocks on this read until the data becomes available when TMSim process writes to the pipe as discussed below.

After reading the pipe on line 714 (FIG. 7), TMSim opens name write pipe ISimReadPipe for writing on line 715 and writes the process ID of TMSim to the pipe on line 716. This write unblocks ISim in FIG. 8 at line 811 and as indicated on line 812, the first item read from this pipe is the process ID of TMSim. During this handshake process, TMSim and ISim may exchange a pre-compiled password to ensure that ISim can be run with only a legitimate copy of TMSim to guard against its use without a license. In addition, TMSim and ISim may use a software license manager (for example, Sentinel License Manager, www.pericosecurity.com).

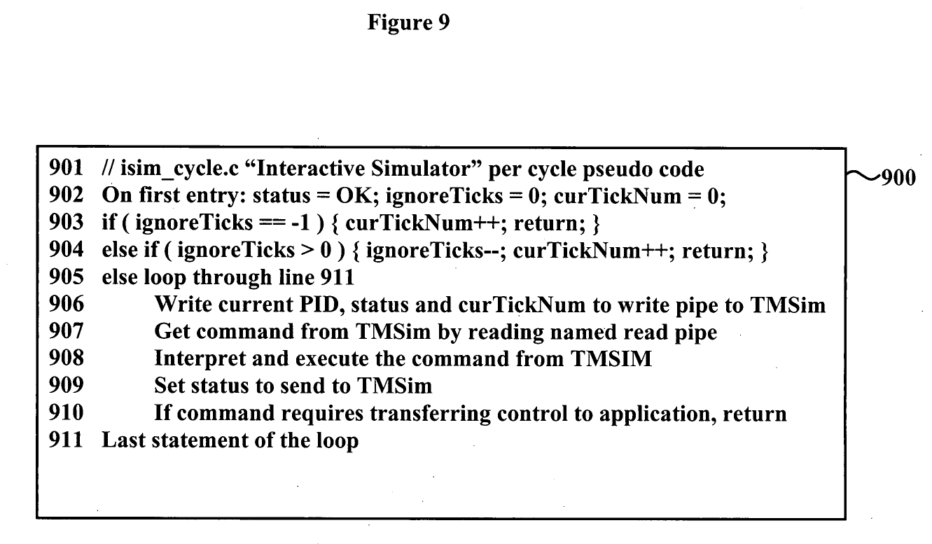

After reading from pipe on line 812 (FIG. 8), line 813 registers signal handlers and lines 814 registers a function to execute on exit or return from ISim. Standard C library provides a functions called on_exit( ) and atexit( ), which is called when the program returns or exits. At this point, the function isim_init return to the code in user application and eventually function isim_cycle (900 in FIG. 9) is called from the iterative loop within ISim.

Line 901 is a comment. Line 902 sets initial status to be sent to TMSim from ISim to be “OK.” It also sets global variables ignoreTicks and curTickNum to zero. The library linked in with the user application, that contains functions isim_init and isim_cycle, also contain declaration of these two global variables. Every time isim_cycle is called, curTickNum is incremented by one. Thus, curTickNum maintains the cycle count for the overall simulation. IgnoreTicks is initially set to zero. This variable controls the processing done in function isim_cycle. If ignoreTicks is minus one, it means the simulation is to be continued without any intervention of isimCycle. This may be because the user wants to run a particular state of ISim to completion. It may also mean that the user has set one (or more) break point(s) via debugger (to be described below) and wants to continue running ISim until the breakpoint hits. If ignoreTicks is minus one when isim_cycle is entered, curTickNum is incremented by one and the function returns (line 903). Thus, cycle count is still maintained. Note that in this mode, minimum computation is done in the function isim_cycle and hence the impact of calling isim_cycle function on the overall speed of ISim is negligible.

If ignoreTicks is greater than zero when isim_cycle is entered, it is decremented by one and curTickNum is incremented by one (line 904, FIG. 9). This is typically a situation when the user requests the simulation to be advanced by N cycles and N is loaded in variable ignoreTicks.

If ignoreTicks is zero when isim_cycle is entered then the code in FIG. 9 in lines 905 through 911 is executed. Line 906 writes current process ID (PID), command status (command executed with/without error, etc.) and curTickNum to the named pipe ISimWritePipe.

Simultaneously, TMSim is running beyond statement 716 (FIG. 7). Line 717 registers signal handlers for TMSim. Line 718 is beginning of a loop, which ends with statement on line 723. We will refer to this loop as the “runloop.” On line 719 (FIG. 7), TMSim reads the status information written by ISim on line 906 (FIG. 9) to pipe ISimWritePipe. Based on the data read, TMSim may update status information for appropriate state(s) on line 720 (FIG. 7). Line 721 receives a command from the user and interprets it. Line 722 sends the command along with the required parameters to ISim via the named pipe ISimReadPipe. Note that some of the commands (for example help command) may be executed locally by TMSim and only the commands that require running of ISim are sent to ISim.

Also, note that line 721 (FIG. 7) calls for receiving a command from the user. Alternatively, the command may be read from a script file prepared by the user. This feature supports execution of ISim under the control of TMSim in batch mode, without interaction with a user.

ISim receives the command, along with any parameters, sent by TMSim on line 722 (FIG. 7) via the named pipe ISimReadPipe on line 907 (FIG. 9). Line 908 interprets this command and executes it. Line 909 determines the status of this command (pass/failure, etc.) for sending to TMSim. On line 910 a determination is made about whether to wait for another command from TMSim. Otherwise, function isim_cycle returns on line 910 (FIG. 9) after appropriately setting the value of the variable ignoreTicks. At this point, the rest of the code in the user application part of ISim is executed for one cycle and eventually, function isim_cycle is called again, which starts executing at line 902 (FIG. 9).

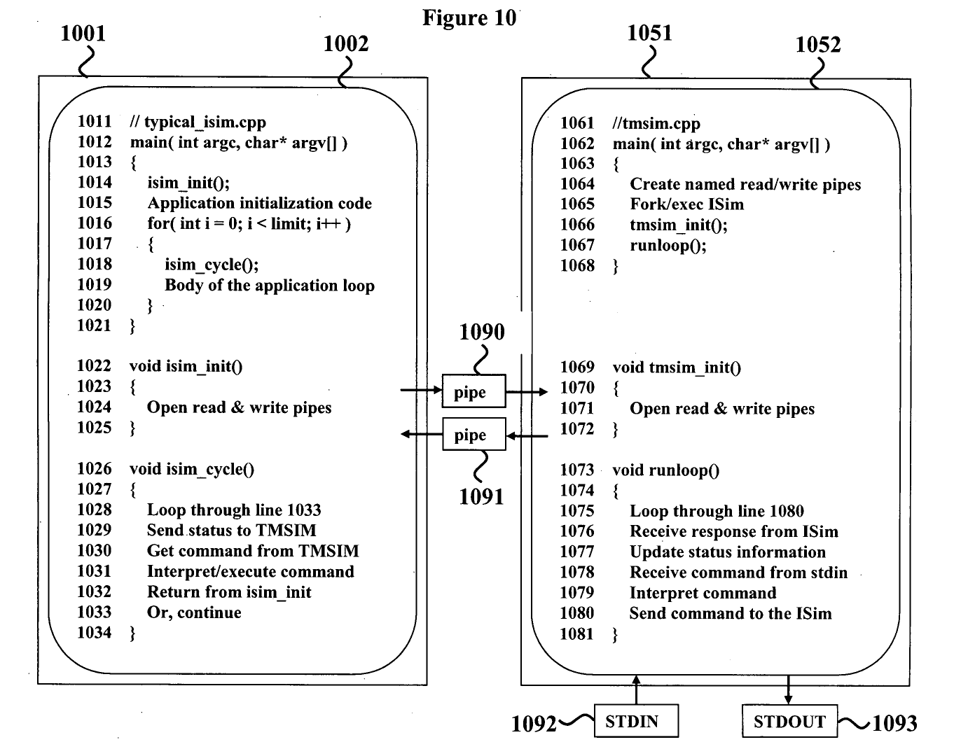

FIG. 10 summarizes operation of TMSim and ISim that is described in FIGS. 7, 8, and 9. The user invokes TMSim (1052) and it may run it in a separate XTERM window (1051). Line 1061 is a comment. Line 1062 is the main function within TMSim. Lines 1063 and 1068 delineate the main function. Line 1064 creates named pipes for read (ISimWritePipe, 1090) and write ISimReadPipe, 1091). Line 1065 forks a child process and executes ISim (1002) optionally in a separate XTERM (1001). Line 1066 calls a function called tmsim_init( ), which abbreviates some of the steps outlined in FIG. 7. Function tmsim_init on lines 1069 through 1072 opens the name pipe ISimWritePipe (1090) for reading and opens named pipe ISimReadPipe (1091) for writing, as indicated by the direction of the arrows. Line 1067 calls function runloop, which is listed on lines 1073 through 1081.

ISim (1002) starts execution at line 1012, which is the main function, which is delineated by lines 1013 and 1021. Line 1014 calls isim_init, which is listed on lines 1022 through 1025. ISim opens named pipe ISimWritePipe (1090) for writing and name pipe IsimReadPipe (1091) for reading. Note that ISim write to name pipe 1090 and TMSim reads from it, whereas TMSim writes to name pipe 1091 and ISim reads from it.

Line 1015 is the application initialization code in ISim. Lines 1016 through 1021 are the main loop in ISim. Line 1018 is a call to isim_cycle listed on lines 1026 through 1034 and is described in FIG. 9. Line 1019 represents body of the application loop. Similarly, function runloop, listed on lines 1073 through 1081, has been described in FIG. 7. Note that TMSim receives input from a user via standard in (STDIN, 1092) and output from TMSim appears on standard out (STDOUT, 1093).

A debugger, such as GDB or DDD is a valuable tool in finding coding errors (“bugs”) in the program. A program, which exhibits incorrect behavior, is run under the control of a debugger. A debugger typically supports source code in various languages, such as, assembly, C, C++, Java, etc. It also provides a mechanism to set up one or more “breakpoints.” If the program happens to execute a line where a breakpoint has been set up, the simulation stops just before executing the instruction(s) corresponding to the line. The program developer can then inspect the values of various variables as well as the logic within the program to determine where the error is. The present invention provides a method to optionally attach a debugger to a particular state of ISim and provide novel additional functionality to the debugger. In order to run a debugger and manage its operation with TMSim and ISim, a program we call TMDbg (“Time Machine Debugger”) is executed in parallel, which will be described below.

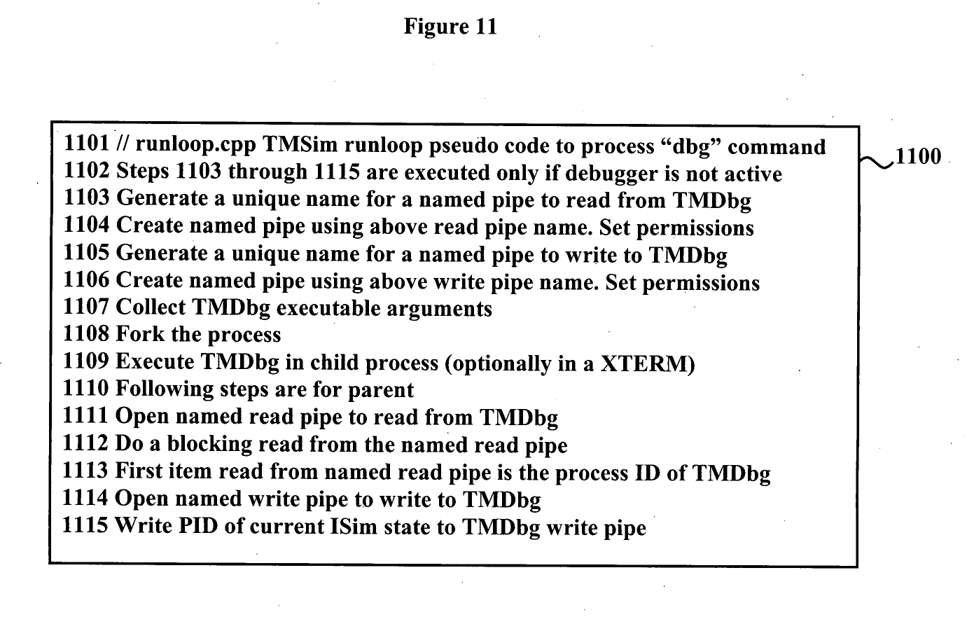

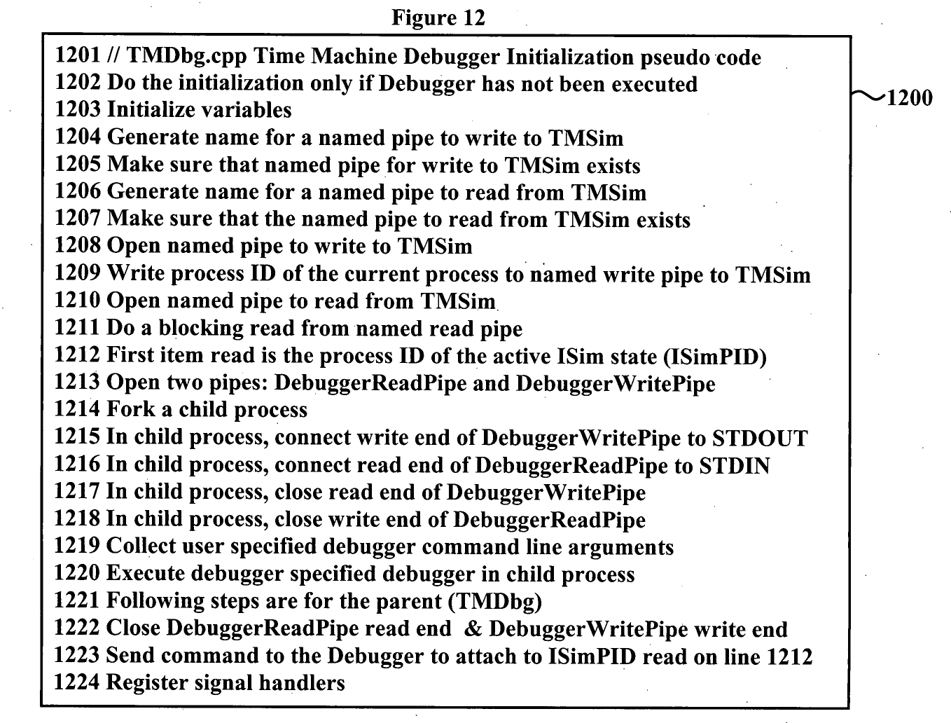

FIG. 11 shows pseudo code (1100) to process user instruction “dbg” in runloop function, basic operation of which is described in FIG. 10. Line 1101 is a comment. Line 1102 indicates that steps 1103 through 1115 are executed only if a debugger is currently not active in unison with TMSim and ISim. Lines 1103 and 1105 generate unique names for named pipe to read input from and write output to TMDbg respectively, using an algorithm similar to the one described in relation to lines 704 and 706 in FIG. 7. Lines 1104 and 1106 generate the corresponding named pipes and set permissions. We refer to the read pipe as TMDbgReadPipe and the write pipe as TMDbgWritePipe. Note that TMSim writes to pipe TMDbgReadPipe and TMDbg reads from it and TMSim reads from pipe TMDbgWritePipe and TMDbg writes to it. Lines 1107 collects command line arguments for TMDbg that may be supplied on the command line for TMSim. Line 1108 forks a child process. Line 1109 executes TMDbg in the child process, optionally in a XTERM. At this point TMDbug process described in FIG. 12 starts running.

Lines 1110 indicates that code in lines 1111 through line 1115 is executed by the parent process (i.e. TMSim) only. Line 1111 opens named read pipe TMDbgWritePipe to read from TMDbg that was created in line 1109. Line 1112 does a blocking read from this named read pipe.

FIG. 12 shows pseudo code for the initialization part of TMDbg (1200). Line 1201 is a comment. Line 1202 indicates that TMDbug initialization in FIG. 12 is done only on startup. Line 1203 initializes local variables. Lines 1204 and 1206 generate unique names for named pipe to write output to TMSim (TMDbgWritePipe) and read input from TMSim (TMDbgReadPipe), using an algorithm similar to the one described in relation to lines 804 and 806 in FIG. 8. Lines 1205 and 1207 make sure that the named pipes corresponding to the names above exist. Since TMSim creates these pipes on lines 1104 and 1106 (FIG. 11) before TMDbug is executed in a child process, this test should pass, if TMSim successfully created these pipes. Line 1208 opens the name write pipe TMDbgWritePipe for writing. Lines 1209 writes process ID of the current process (i.e. TMDbg) to the write pipe. Line 1210 opens the named pipe TMDbgReadPipe to read from TMSim. Line 1211 does a blocking read from this named pipe.

The data written by TMDbug on line 1209 is read by TMSim, which is blocked on line 1112. Line 113 notes the read data to be the process ID of TMDbg, which is anyway known to TMSim, since fork system call on line 1108 returns process ID of TMDbug to TMSim. Line 1114 opens named write pipe TMDbgReadPipe to write to TMDbug. Line 1115 writes the process ID of ISim state currently attached to TMSim to the write pipe TMDbgReadPipe. This completes initialization of TMDbg from TMSim.

The process ID of the currently attached ISim state written by TMSim on line 1115 is read by TMDbg on line 1211 which unblocks it. Line 1212 notes the process ID of ISim the debugger will be attached to. Line 1213 opens two pipes DebuggerReadPipe and DebuggerWritePipe. Line 1214 forks a child process. Lines 1215 through 1220 are executed in the child process. Note that a child process inherits file descriptors from the parent process. Line 1215 connects the write end of DebuggerWritePipe to STDOUT. Line 1216 connects read end of DebuggerReadPipe to STDIN. Lines 1217 and 1218 close read end of DebuggerWritePipe and write end of DebuggerReadPipe respectively.

Line 1219 collects user specified command line options for the debugger as well as the name of the debugger executable (e.g. GDB). Line 1220 executed the specified debugger in the child process. Line 1221 indicates that lines 1222 through 1224 are executed in the parent process, i.e. TMDbg. Lines 1222 closes the write end of DebuggerWritePipe and read end of DebuggerReadPipe. Line 1223 sends a command to the Debugger to attach itself to ISim PID read on line 1212. Line 1224 registers signal handlers for TMDbg process.

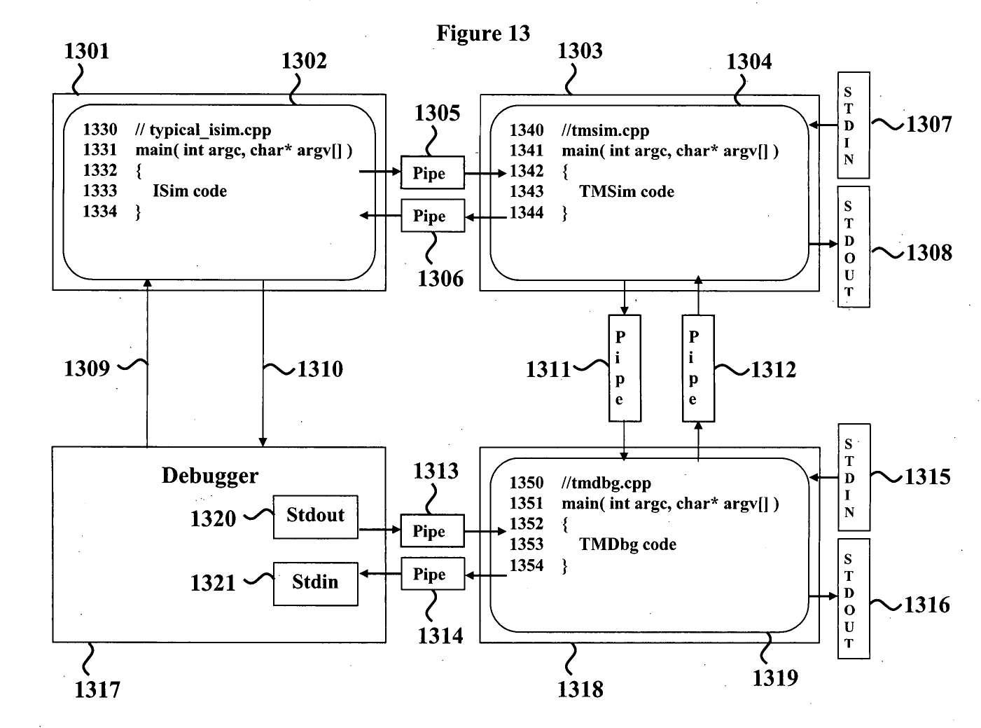

FIG. 13 gives an overview of how TMSim, ISim and optionally TMDbg as well as the debugger specified by the user interact with each other and with the user at run time. Note that we show user provides input at run time in FIG. 13. However, these programs could be run in a batch mode, where the user input may be read from input file(s) prepared by the user and the output may be written to output file(s). User runs TMSim (1304), optionally in a XTERM window (1303) by specifying the executable name as well as the command line arguments. Since TMSim spawns child processes and executes ISim (1302), TMDbg (1319) and the debugger (1317), separate command line arguments may be specified for all four programs. TMSim forks a child process and runs ISim (1302), optionally in XTERM 1301. TMSim and ISim communicate with each other through named pipes ISimWritePipe (1305) and ISimReadPipe (1306). TMSim receives input from the user via STDIN (1307) and provides output via STDOUT (1308).

When the user requests to attach a debugger to ISim, TMSim forks a child process and runs TMDbug (1319) in it, optionally in a XTERM (1318). TMSim and TMDbug communicate with each other through pipes TMDbgReadPipe (1311) and TMDbgWritePipe (1312). TMDbug forks a child process and runs the debugger (1317) specified by the user. TMSim and the debugger communicate with each other through pipes DebuggerWritePipe (1313) and DebuggerReadPipe (1314). Note that the debugger is run completely in the background. Furthermore, STDIN (1321) from the debugger (1317) is connected through TMDbg (1319) to STDIN from TMDbg (1315). Similarly, STDOUT (1320) from the debugger (1317) is connected through TMDbg to STDOUT from TMDbg (1316). Due to these connections, the user perceives that TMDbg is the debugger, whereas in reality TMDbg is only communicating with the debugger of user's choice. Note that TMDbg may provide enhanced functionality over the debugger. For example, for C and C++ debugging, TMDbg may provide graphical user interface for GDB debugger with additional features. As indicated before, a GUI may integrate all the components of FIG. 13 to provide a unified interface to the user.

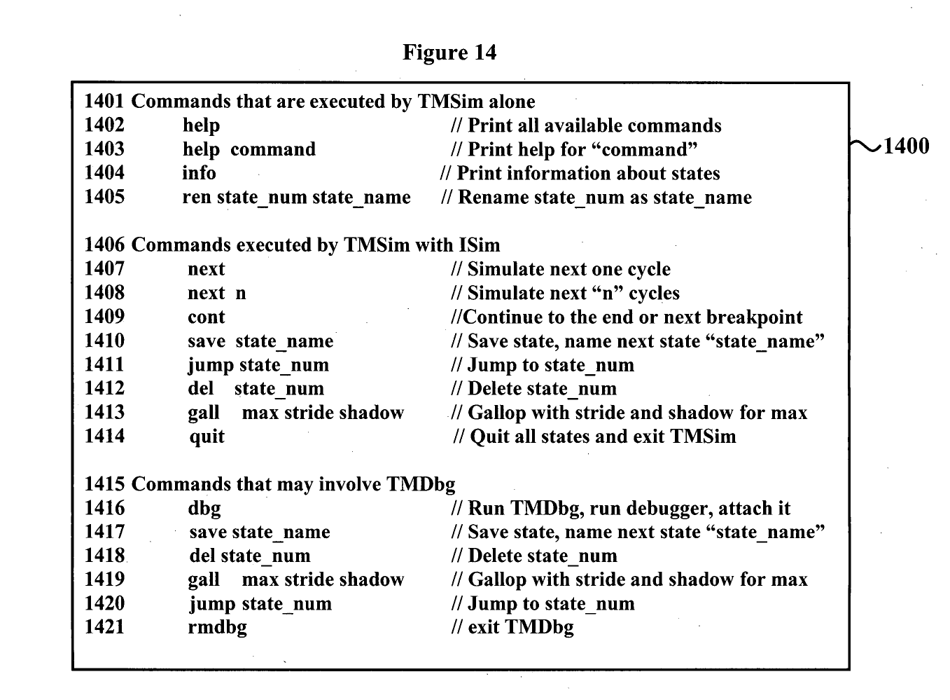

An example set of user commands (1400) are listed in FIG. 14. TMSim alone may execute some commands (1402 through 1405), it may execute some commands with ISim (lines 1407 through 1414) and it may execute some commands with TMDbg (Lines 1416 through 1421). “Help” (1402) command prints help message on all the available user commands supported by TMSim. “help command” (1403) prints help for a specific “command.” “info” (1404) command prints information about various states saved during the simulation. A state is an ISim processes which is at a particular point in execution. Each state has user visible attributes maintained by TMSim, such as, name, cycle number to which it has progressed and a state identification number. Each state may also have user invisible attributes, which are maintained by TMSim, such as, process ID. TMSim may maintain this information in a list. “ren” command may be used by the user to rename a state.

TMSim together with ISim executes example commands 1407 through 1414. The “next” command advances the simulation by one cycle and “next n” command advances the simulation by “n” cycles. When TMSim receives a “next” command, it sends the command as well as the count by which to advance the simulation to isim_cycle function in ISim, which sets ignoreTicks variable (FIG. 9) to the specified count and returns. As shown in logic on line 904, ignoreTicks is decremented by one every time isim_cycle is called, until ignoreTicks is zero, at which point ISim sends the status to TMSim as described on lines 905 through lines 911 in FIG. 9. Thus, from user perspective the simulation advances by the specified count. Note that when ISim is advancing by the specified count, the only overhead is a call to isim_cycle and decrementing of ignoreTicks by one. This leads to an insignificant decrease in simulation speed of ISim while running ISim under the control of TMSim as opposed to running the user application without modification according to the present invention.

When TMSim receives a “cont” command (line 1409, FIG. 14) from the user, it sends it to isim_cycle function in ISim (line 907, FIG. 9). The function isim_cycle sets ignoreTicks variable to −1 and returns from the function. When this function is called every clock cycle, curTickNum is incremented by one and the function returns (line 903, FIG. 9). Note that after sending the command to ISim from line 722 (FIG. 7) TMSim waits for response from ISim (line 719, FIG. 7). Rather than doing a blocking read from the name pipe connected from TMSim to ISim, TMSim suspends the process (by executing pause( ) function). ISim continuing to run may stop in three ways.
1. The program ISim completes by executing a return or exit. Since a function to execute on exit or return is registered (line 814 FIG. 8, using a call, such as on_exit( ) or atexit( )), it is called and it writes current PID, status indicating normal completion, as well as curTickNum to the write pipe to TMSim and sends signal SIGUSR1 to TMSim. Corresponding signal handler in TMSim gets called and it sets an internal signal, “receivedSigusr1” to true indicating that SIGUSR1 was called. After the signal handler returns, the pause on line 719 in TMSim also returns. TMSim determines from the value of receivedSigusr1 that ISim has completed execution. It reads the status from the ISim read pipe and lets the user know that the state has completed. If this is the last remaining state, TMSim exits. Otherwise, TMSim prompts the user to enter the state number to jump to.
2. ISim aborts due to an exception, such as, segmentation fault, floating point exception, etc. TMSim has registered signal handlers on line 717 for all the possible signals. If ISim aborts, an appropriate signal handler is called. This signal handler writes current PID, status-indicating type of abort as well as curTickNum to the write pipe to TMSim and sends signal SIGUSR1 to TMSim. Corresponding signal handler in TMSim gets called and it sets an internal signal, “receivedSigusr1” to true indicating that SIGUSR1 was called. After the signal handler returns, the pause on line 719 in TMSim also returns. TMSim determines from the value of receivedSigusr1 that ISim has completed execution. It reads the status from the ISim read pipe and lets the user know that the state has aborted with exception. If this is the last remaining state, TMSim exits. Otherwise, TMSim prompts the user to enter the state number to jump to. Yet another alternative is for TMSim to take specific action based on input from a script file.
3. The user may request that TMDbg be run along with TMSim and debugger may be attached to ISim and one or more breakpoint(s) may have been planted in ISim code. If this is the case, when “cont” command is executing, the execution may stop if the code happens to execute a line of code where a breakpoint has been planted and the condition is true if the breakpoint is a conditional breakpoint. In this case, TMDbg indicates to the user via STDOUT (1316, FIG. 13) of this fact and waits for further action from the user. TMDbg also writes to the pipe TMDbgWritePipe status indicating that debugger breakpoint fired and sends SIGUSR2 signal to TMSim. Corresponding signal handler in TMSim gets called and it sets an internal signal, “receivedSigusr2” to true indicating that SIGUSR2 was called. After the signal handler returns, the pause on line 719 in TMSim also returns. TMSim determines from the value of receivedSigusr2 that the debugger breakpoint has fired. It reads the status from the TMDbgWritePipe, registers the fact in some internal variable and may optionally let the user know that the ISim state has hit a breakpoint.
   When TMSim receives a “save state_name” command (line 1410, FIG. 14), the user is requesting that a new process be spawned with name “state_name”, thus starting a parallel universe. TMSim sends the “save” command to the currently active ISim. When TMSim verifies that the “save” command has successfully been executed by ISim, it makes an entry in a list it maintains for the new state and saves “state_name” in it along with other information, such as serial number, process ID and cycle number, which was described above.

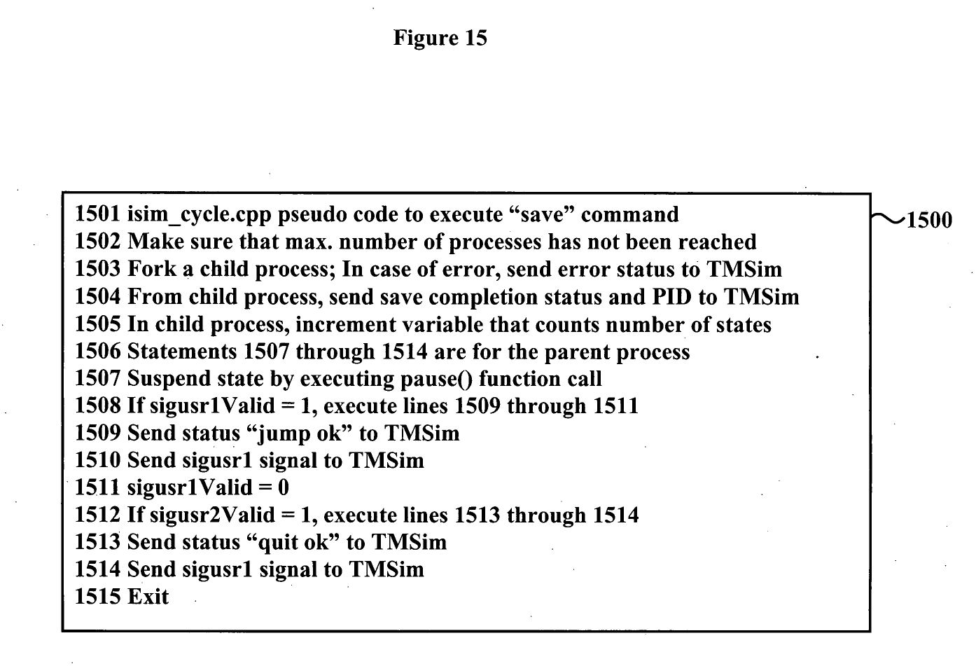

FIG. 15 lists pseudo code (1500) for the isim_cycle function that executes a “save” command. Line 1501 is a comment. Line 1502 is a test-to check whether the number of states of ISim exceeds the maximum number allowed. Line 1503 forks a child process. If this fork fails, an error status is sent to TMSim. Line 1504 is executed only in the child process, which sends “save” command completion status to TMSim through the write pipe ISimWritePipe and sends SIGUSR1 signal to TMSim so it gets out of the pause state on line 719 (FIG. 7) as described before. The child process also sends its process ID (PID) to TMSim. TMSim saves this PID, along with other attributes of the state as described before in a list. This PID is used by TMSim while jumping to this state or while deleting this state as described below. Line 1505 increments a global variable, that counts the number of states of ISim, and which is used in line 1502.

Line 1506 states that line 1507 through 1514 are executed only in the parent process. Line 1507 suspends the parent process by executing a pause function call. Under normal conditions, the parent gets out of this state when a user either jumps to this state or deletes this state as described below.

If TMDbg has been attached when the save command is executed, TMSim sends a command to TMDbg to save information such as all the breakpoints, watch points, and stack trace data in “debug context” data associated with the state and optionally send this information to TMSim. TMDbg then sends a command to the debugger to detach from the currently active ISim process. TMSim sends the save command to the ISim state only after these tasks are done. After TMSim receives a status from ISim indicating that the “save” command is successful, it sends a command to TMDbg to attach the debugger to the new ISim PID it has received as a part of the status. It may also optionally command TMDbg to have the debugger to set all the breakpoints and watch points for the saved states.

When TMSim receives “jump state_num” command (line 1411, FIG. 14), the user intends to save the status of current ISim process and jump to state number “state_num.” TMSim first ensures that state number “state_num” has been saved in the list of states. It then sends a command to suspend the current state to ISim. ISim responds by sending a status back to TMSim indicating command success along with the signal SIGUSR1. ISim then calls function pause( ) to suspend the current process. TMSim then finds the PID corresponding to the state number “state_num” that the user wishes to jump to from the list that it maintains. It then sends signal SIGUSR1 to that PID using the kill function call and suspends itself using the pause function call. The process corresponding to the PID is in a suspend state on line 1507 (FIG. 15) when the “save” command was executed by ISim. SIGUSR1 signal handler in ISim sets sigusr1Valid to 1 and when it returns, pause function call on line 1507 (FIG. 15) also returns. Since sigusr1Valid variable has value 1, lines 1509 through 1511 (FIG. 15) are executed. Line 1509 sends status “jump ok”, along with the PID of the process to TMSim for verification. Line 1510 sends SIGUSR1 signal to TMSim, which gets it out of the suspend state on line 719 as described before. Line 1511 resets the value of sigusr1Valid variable to 0. This completes the “jump” command. The process corresponding to “state_num” is the ISim process now active and communicating with TMSim. All the user commands at this point are sent to this process and are executed in the isim_cycle function in this process.

If TMDbg has been attached when the “jump state_num” command is executed, TMSim commands TMDbg to save the debug context for that state. It then sends a command to the active ISim process to suspend and then sends a command to TMDbg to have the debugger detach from the currently active ISim process then jumps to the specified “state_num.” This is followed by TMSim sending a command to TMDbg to attach the debugger to the new ISim process and set all the breakpoints and watch points saved in the debug context associated with that process.

When TMSim receives “del state_num” command (line 1412, FIG. 14), the user intends to delete state number “state_num.” TMSim first ensures that state number “state_num” has been saved in the list of states. It then accesses the PID of the state corresponding to the state number “state_num” from the list it maintains and removes the entry corresponding to the state number from the list. It then sends signal SIGUSR2 to the PID above using kill function call and suspends itself using the pause function call. The process corresponding to the PID is in suspend state on line 1507 (FIG. 15) when “save” command was executed by ISim. SIGUSR2 signal handler in ISim sets sigusr2Valid to 1 and when it returns, pause function call on line 1507 (FIG. 15) also returns. Since sigusr2Valid variable has value 1, lines 1513 through 1515 (FIG. 15) are executed. Line 1513 sends status “quit ok”, along with the PID of the process to TMSim for verification. Line 1514 sends SIGUSR1 signal to TMSim, which gets it out of the suspend state on line 719 as described before. Line 1515 makes a call to exit the process.

If TMDbg has been attached when the “del state_num” command is executed, TMSim sends a command to TMDbg to delete the debug context associated with the process.

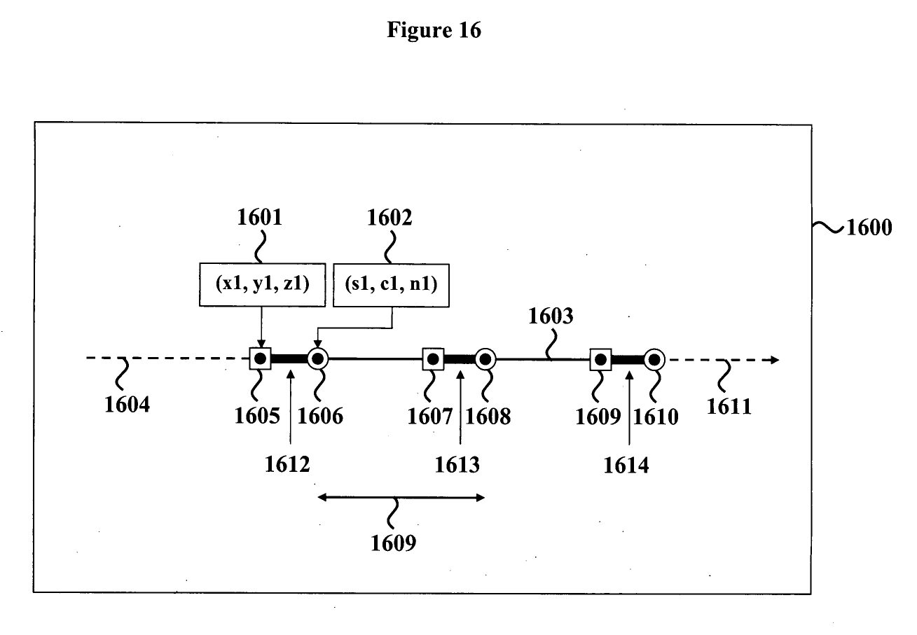

When TMSim receives “gall max stride shadow” command (line 1413, FIG. 14), the user intends to run ISim in “galloping mode”, a new concept introduced by the present invention. Galloping mode is described in FIG. 16, where 1600 gives an overview. Line segment 1604 represents ISim running in the past, for which no states have been saved. A state represented with a filled circle and an open circle around it (1606, 1608 and 1610) are user visible saved states. A state represented with filled circle and an open square around it (1605, 1607 and 1609) are states that are maintained by TMSim and ISim, but invisible to the user. Invisible state 1605 has state information 1601 associated with it and the state is invisible to the user. State 1606 has visible state information 1602 associated with it. Example state information 1601 consists of state number (X1), cycle number (y1) and name of the state (z1). We refer to the difference in the cycle count between two user visible states as “stride.” For example, 1609 is stride between states 1606 an 1608. We refer to the difference in the cycle count between a user visible state and immediately preceding user invisible state as the “shadow” or “footprint.” Thus, 1612, 1613 and 1614 are shadows for states 1606, 1608 and 1610 respectively.

The preceding discussion explains the arguments of the “gall max stride shadow” command. This command indicates that ISim be run a maximum of “max” times. Each run should consist of stride “stride” and shadow “shadow.” We explain the execution of the “gall” command using the illustration in FIG. 16. Assume that the “gall” command is given from state 1606. We assume that state 1606 is the state that ISim is presently in and that this state has not been saved. The following steps are executed repeatedly “max” times to execute the “gall” command:
1. Save state 1606 (this is done only the first time in the loop)
2. Advance simulation by count=stride−shadow
3. Save invisible state 1607
4. Advance the simulation by count=shadow
5. Save visible state 1608

We assume that during the galloping mode all the breakpoints have been disabled. Operation of galloping mode with breakpoints enabled is discussed shortly. The purpose of the galloping mode is to create child processes at regular interval. One use is to help software developer in debugging an application program. Typically, the developer tries to find the cause for an incorrect value for one or more variables in a program. This process typically involves going back to find where the incorrect value is set. This obviously requires the programmer to run the program again, since there is no prior art method for running a program back in time. Galloping mode described according to the present invention provides convenient way for the programmer to effectively jump back in time to another state and explore the program status.

Consider a case where ISim has been run in galloping mode with the final states as shown in FIG. 16. Furthermore, consider a case where the current state is 1608 and the user wishes to go back “n” cycles, where “n” is less than “shadow.” In this case “next -n” command, which asks for the simulation to go back “n” clocks can be implemented by optionally deleting state 1608, jumping to state 1607, saving that state and advancing the simulation in the child process to “shadow -n” clocks. If the “shadow” is a small number, above process may appear instantaneous to the user.

Note that it is not a requirement that the states, such as 1605 and 1607 be invisible to the user. These states have been made invisible to the user to create an illusion of the ISim program having ability to go back in time.

According to prior art, given a point in execution of a program it is very difficult to reconstruct the path taken by the program up to that point. This is because of may factors, such as, conditional statements, a function getting called from various points within the program and processor registers getting used to hold multiple variables at different point in execution. However, the galloping mode according to the present invention offers a way to create an illusion of being able to rewind the simulation back at instruction level, either high level language instruction level or machine instruction level. In order to realize this, debugger is attached to ISim in the current state, optionally without the knowledge of the user. A command is given to the debugger to dump stack trace, for example by using “where” command in case of “GDB” debugger. Next, jump is made to the nearest shadow state and the state is saved. The child process is then advanced by a count one less than the count where the original state was. Subsequently, the debugger is attached to the child process and a breakpoint is planted to the statement preceding the statement from which the user wanted to go back. At this find a “cont”, continue command is executed. When the breakpoint is executed, the stack trace is compared to the original stack trace.

In the present description of “gall” command, the states are saved at regular intervals. Optionally, a script may describe the points at which visible and invisible states should be saved. Furthermore, this script may specify combination of breakpoints and advancement of ISim by certain number of clocks for the galloping mode. The programmer may use this facility to set a “safe” breakpoint which marks the beginning of a set of events that may be of value in debugging the program.

When TMSim receives “quit” command (line 1414, FIG. 14), the user intends to destroy all the ISim processes and quit TMSim as well as TMDbg and the debugger. TMSim executes this command by repeatedly executing the “del” command for all the states in the list of states that it maintains. Subsequently, it sends a command to TMDbg to delete the debugger process and to exit. Finally TMSim exits.

Another feature of TMSim is “safe mode” where ISim runs in galloping mode with a shadow of suitable number of cycles and where only one or a few recent states are saved. In this case, if the program eventually crashes, there will always be one or more states from which the work done up to that point could be salvaged or cause of the crash could be explored using TMDbg. The safe mode could also be used to capture all the input that are responsible for the crash of the application program.

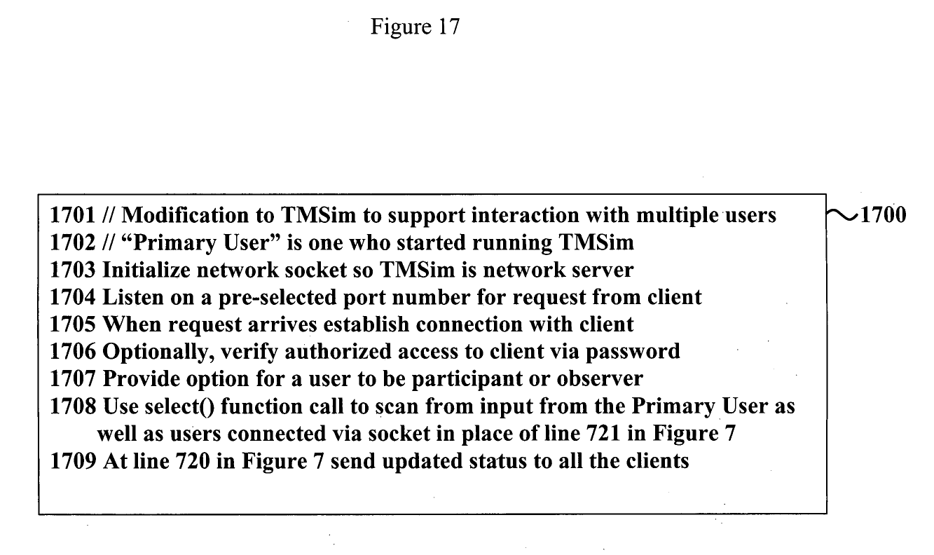

FIG. 17 shows pseudo-code modifications to TMSim to support interaction with multiple users (line 1501). When multiple users are interacting with TMSim, the user that started running TMSim is referred to as the “Primary User” (line 1502) and other users as “Secondary Users.” Line 1503 initializes network socket so TMSim has functionality to be a network server. Line 1504 has code to listen for a connection request from a client, either on the same computer or another computer. Line 1505 processes incoming request and establishes connection with the socket. At this point the code on line 1504 is active and can support connection request from another client. Line 1506 optionally verifies that the new user has legitimate access to the TMSim session, by using mechanism, such as, password. Line 1507 provides option to the user to be either as an active participant or as an observer. An active participant is one who gives commands to control operation of TMSim in general and that of ISim in particular. TMSim may provide commands for a user to change participant/observer status. Line 1508 indicates that line 721 in FIG. 7 is modified to receive input from multiple users using a call, such as, select( ), which scans for input from all the specified file descriptors. Line 1509 indicates that line 720 in FIG. 7 should be modified to send the updated status to all the clients. Thus, multiple users can interact with the simulation control program code in a single execution instance of the simulation control program code.

Conventional computer programs have a large number of lines and various modules of the software are routinely developed at multiple locations. When these modules are integrated into a prototype product or final product, it is common to encounter complex bugs that require analysis by team of developers at multiple locations. Present invention provides a novel feature whereby developers at multiple locations can participate in the debugging session in progress.

This feature is very general and may be used in other situations, such as, a computer game, where a secondary user connects to TMSim and takes control of the game at previously saved process point.

ISim could be further enhanced with functions, such as, isim_beforeSaveState( )/isim_afterSaveState( ) which would be called before/after ISim executes a save command. The code in these functions may be supplied by the user and may do opening or closing of the files such that output from a given state goes only to a particular file. These functions may also refresh screen output and/or ensure that the peripheral devices, if controlled by ISim, are in proper state. Similarly, functions, such as, isim_beforeJump( )/isim_afterJump( ), which would be called before ISim executes a jump command. The code in these functions may be supplied by the user for appropriate additional functionality. This functionality may be further enhanced to run ISim up to a certain point and then save states and run each one of the states beyond that point using different stimulus. This will enable running two or more program runs that shared some initial code segment and will decrease the overall time needed to complete multiple simulations.

We have considered a single major iterative loop from which the function isim_cycle is called. This could be generalized for the case of multiple loops. A call from a particular loop may be identified by a parameter passed to isim_cycle. In this case, multiple variables equivalent to ignoreTicks and curTickCount (FIG. 9) will be maintained by ISim. TMSim would have to be modified to maintain multiple levels of cycles. The TMSim modification to maintain multiple levels will be apparent to those skilled in the art, in view of this detailed description.

A further modification to TMSim is to provide ability to control multiple distinct Application Programs. Various data structures in TMSim will have to be replicated and the GUI, if available, will open separate windows for separate applications. In this way, a computer system may have only one license of TMSim but could run multiple PURE-fied application programs.

We now describe a modified implementation of “save” and “jump” commands that enable TMSim to control ISim at instruction level rather than at the iteration loop level discussed so far. This scheme uses a mechanism different from sending the above two commands via pipe from TMSim to ISim. The Linux and Unix operating systems provide signals from the operating system to a running program as discussed above. Two signals, called SIGUSR1 and SIGUSR2, are reserved for use by the application and can be sent from one process to another using a “kill” system call. In this modified scheme, SIGUSR1 is sent from TMSim to an ISim process to communicate the “save” command and SIGUSR2 is sent from TMSim to an ISim process to communicate the “pause process” command, which is used to implement the “jump” command. This scheme also uses the SIGCONT signal to wake up a paused process to implement part of the “jump” command. Table 3 shows the modified scheme for the “save” command.

TABLE 3

| Operations in TMSim | | Operations in ISim | |
|---|---|---|---|
| 1. | If debugger is attached, get | | |
| | current debug context from | | |
| | debugger. e.g. “info break” in | | |
| | gdb. | | |
| 2. | Get current line number/address | | |
| | of the current instruction from | | |
| | debugger. e.g. “where” in gdb. | | |
| 3. | Save information about current | | |
| | state. | | |
| 4. | Save command parameters | | |
| 5. | Send SIGUSR1 to ISim | | |
| 6. | Send “continue” command to | | |
| | debugger if it is attached to | | |
| | current state | | |
| 7. | Do a blocking read from a pipe | | |
| | to ISim | 8. | Receives SIGUSR1 signal |
| | | 9. | Send handshake signal to |
| | | | TMSim |
| | | 10. | Do blocking read from |
| | | | TMSim |
| 11. | Receive handshake signal from | | |
| | ISim | | |
| 12. | If debugger is attached to the | | |
| | current state, detach it | | |
| 13. | Send command to ISim to fork | | |
| | the current state via pipe | | |
| 14. | Do a blocking read from the | | |
| | pipe to ISim | 15. | Receive command to fork |
| | | | from TMSim via pipe |
| | | 16. | Make fork system call. |
| | | 17. | If in parent process after fork, |
| | | | call pause_current_state |
| | | | function, where it makes |
| | | | pause system call and waits to |
| | | | receive a signal. |
| | | 18. | If in child process, send ok |
| | | | status along with the PID of |
| | | | the child process to TMSim |
| | | | via pipe |
| | | 19. | Do blocking read from |
| | | | TMSim |
| 20. | Receive status from ISim along | | |
| | with PID of child process | | |
| 21. | Save information about the new | | |
| | child process and mark it as | | |
| | current state. | | |
| 22. | If debugger was attached to the | | |
| | saved state, attach it to the new | | |
| | current state | | |
| 23. | Set temporary breakpoint at the | | |
| | point where the previous state | | |
| | from info in step 2 | | |
| 24. | Send continue command to the | | |
| | debugger | | |
| 25. | Send handshake message to the | | |
| | child process, via pipe | | |
| 26. | Do a blocking read from pipe | | |
| | | 27. | Receive handshake message |
| | | | from TMSim |
| | | 28. | Send handshake message |
| | | | to TMSim |
| | | 29. | Restore SIGUSR1 handler |
| 30. | Receive handshake signal from | | |
| | pipe. “save” command is | | |
| | complete | | |

Table 3 shows operations carried out by TMSim in the left column and those carried out by ISim on the right column. It shows the operation with and without a debugger attached to ISim. If the debugger, such as GDB, is attached, it is assumed that ISim is paused, waiting to receive command either from TMSim for from the debugger, where latter is provided by the user.

Table 4 shows a modified implementation of the “jump” command.

TABLE 4

| Operations in TMSim | | Operations in ISim | |
|---|---|---|---|
| 1. | If debugger is attached, get | | |
| | current debug context from | | |
| | debugger. e.g. “info break” in | | |
| | gdb. | | |
| 2. | Get current line number/address | | |
| | of the current instruction from | | |
| | debugger. e.g. “where” in gdb. | | |
| 3. | Save information about current | | |
| | state. | | |
| 4. | Send SIGUSR2 to current ISim | | |
| | state | | |
| 5. | If debugger is attached, send | | |
| | continue command to it. | | |
| 6. | Do a blocking read from ISim | | |
| | pipe | | |
| | | 7. | Receive SIGUSR2 signal |
| | | 8. | Send handshake signal to |
| | | | TMSim |
| | | 9. | Call function |
| | | | pause_current_function, |
| | | | where it makes pause system |
| | | | call and waits to receive a |
| | | | signal from TMSim |
| 10. | Receive handshake signal from | | |
| | ISim | | |
| 11. | If debugger is attached to current | | |
| | state, delete the debug context | | |
| | and detach debugger from | | |
| | current state. | | |
| 12. | Restore all the information of | | |
| | the target state of the jump, | | |
| | including the process ID, from | | |
| | information saved for all the | | |
| | states. | | |
| 13. | If debugger was attached to the | | |
| | target, access debug context | | |
| | also. In this case, set up debug | | |
| | context in the debugger for | | |
| | the target of the jump | | |
| | command. Set a temporary | | |
| | breakpoint at the point where | | |
| | the program was as determined | | |
| | in step 2 of “save” command. | | |
| | Send continue command to the | | |
| | debugger. | | |
| 14. | Send SIGCONT signal to the | | |
| | target of jump | | |
| 15. | Do a blocking read from pipe to | | |
| | ISim | | |
| | | 16. | ISim which is target process |
| | | | of jump receives SIGCONT |
| | | | signal and enters the handler. |
| | | | Set a flag for information |
| | | | purpose and restore |
| | | | SIGCONT handler. |
| | | 17. | Receipt of SIGCONT makes |
| | | | the target of jump exit the |
| | | | pause state it entered in line |
| | | | 17 in “save” or line 9 |
| | | | in “jump” command |
| | | 18. | Send handshake signal to |
| | | | TMSIM |
| | | 19. | Restore SIGUSR1 handler |
| 20. | Receive handshake message | | |
| | from target of jump ISim | | |
| | process. | | |
| 21. | If debugger is attached, the | | |
| | program runs and stops at | | |
| | temporary breakpoint. This is | | |
| | exactly the point where this state | | |
| | was in step 2 of the “save” | | |
| | command. The debugger deletes | | |
| | the temporary breakpoint. | | |
| 22. | Command is complete. Target | | |
| | state of the jump command is | | |
| | exactly at the point where it was | | |
| | saved in the “save” command. | | |

The modified scheme, shown in Tables 3 and 4, provides ability for TMSim to save and restore ISim states at instruction level granularity. As a result, if ISim is to be run under the control of a debugger, isim_cycle call is not needed. Only isim_init call is sufficient to initialize the communication between TMSim and ISim.

In the first implementation of TMSim and ISim, TMSim had control over the ISim operation at granularity, which is integer number of iterations through the loop from which function isim_cycle is called in ISim. In contrast, the modified implementation, which uses the ability of the debugger to set breakpoints, provides control granularity at program instruction level. A debugger, such as GDB is capable of setting breakpoints at high-level program line level (for example, a statement in C language). GDB is also capable of setting breakpoint at machine instruction level (e.g. Intel X86 machine instruction level, if the program is run on a computer with a processor compatible with Intel X86 architecture). Thus, the scheme presented in Tables 3 and 4 provides TMSim to control program at granularity, which is machine instruction level.

Note that Tables 3 and 4 show modified implementation in a case where there are no error conditions, such as, fork fails. It will be obvious to someone skilled in the art how to incorporate detection and recovery from such errors.

We have described the implementation for Linux and Unix operating systems. As pointed out before, the present invention could be implemented on other operating systems. For example, a Unix like system call library is available for Microsoft Windows operating system (UWIN—Unix for Windows, available at the URL of www.usenix.org/publications/library/proceedings/usenix-nt97/full_papers/korn/korn.pdf, also Cygwin is a Linux-like environment for Windows, available at the URL of www.cygwin.com). Similarly, the present invention is not restricted to applications written in C or C++. Most languages support calling functions written in C or C++, or the code required may be developed in other languages with suitable system calls.

The present invention may be used to offer a wide variety of products in many markets. The application program under study can be modified by inclusion of isim_init and isim_cycle and is recompiled. Such modified application we refer to as PURE-fied. A computer system will install TMSim comprising simulation control program code as a separate program installed on the computer system or the OS of the computer system may be suitably modified to include the functionality of TMSim. An example of a graphical user interface is provided in FIG. 4; such interface menus can be provided through an interface of the separate program installed on the computer or can be provided through a “RUN” or “Control Panel” menu of the OS, or the like. We provide a few examples of the use of TMSim running PURE-fied applications below.

TMSim may be offered as a debugger product that provides a capability to run simulation either forward or backward in time. It may also provide ability to attach a debugger of user's choice to a particular state of the program, along with the debug context. This product may be offered to debug programs written in a wide variety of programming languages, such as, C, C++, Fortran, Java, Verilog, VHDL. Such a product would enable debugging a program without having to restart the program execution from the beginning. Such a product would enable the user to capture all the inputs that lead to the program failure without having to restarting the program execution from the beginning. Existing commercial debugger may be interfaced with TMSim according to the present invention.

TMSim may be offered as a computer run-time environment product for running programs so that if they crash, one or more earlier states are guaranteed to be saved. In case of such a crash, the product may offer a way to recover the earlier state and either continue the program execution with different stimulus. Alternatively, the product may offer ability to debug the cause of the crash. The product may be used to save states periodically either for documentation purposes or for recovery in case of program crash.

TMSim may be offered as a computer run-time environment product for running multiple instances of a program so that the total execution time for running the programs is reduced. For example, consider two instances of running a program. The first instance consists of stimulus “A” followed by stimulus “B.” The second instance consists of stimulus A followed by stimulus “C.” In this case, the product may provide a way to save two states after running one program instance with stimulus “A.” This would be followed by continuing one state with stimulus “B” and continuing the other state with stimulus “C.” Since the two instances share the portion of the program with stimulus “A,” the total time to run the program will be reduced. If many such instances share common portions, significant reduction in the execution time may be realized.

TMSim may be offered as a product that enables user one or more opportunities to change the stimulus they provided to the program. For example, it may be used to let user go back to certain point in playing a computer game and continuing with the same or different stimulus. We note that “cheats codes” for many computer games are available, which enable starting the game at a particular point. The present invention allows much more flexibility to the user to save the state and jump to the saved point in the game at arbitrary points. TMSim may offer fault tolerance in embedded systems by providing ability to revert back to a saved state when the program crashes. This is feasible since many embedded systems run OS, such as, Linux.

The operations described above as being performed by the system in accordance with the invention can be performed by a computer processing apparatus, or system. In accordance with well-known techniques, such operations on a computer processing apparatus can be implemented by means of installing processing software onto the computer processing apparatus. This is typically achieved by means of a program product containing appropriate program instructions (in code or software), with which those skilled in the art will be familiar. For example, the program product may comprise optical media such as a data CD or DVD on which is recorded appropriate software to cause the computer apparatus to perform the described operations when the software is installed on the computer, or the program product may comprise other signal bearing media including a data signal that can provide the program instructions to the computer. Likewise, any software to be installed on any of the computing devices described herein can be achieved with such program product devices, to install the appropriate software onto the device for execution. Furthermore, in accordance with well-known techniques, such operations on a computer processing apparatus can be implemented by means of including the necessary functionality in hardware, for example via one or more integrated circuit chips, or by a combination of hardware and software. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of executing a computer program containing code to be executed, the method comprising:
executing simulation control program code from within an operating system of the computer apparatus;
controlling execution of an interactive simulation program comprising the computer program code modified with at least one function call inserted in a loop code section of the computer program code;
wherein an interactive simulation program child process is in inter-process communication with the executing simulation control program code and wherein the interactive simulation program interactively receives program execution commands from the simulation control program code, such that real-time execution control of the interactive simulation program is achieved with preservation of the computer program behavior.

2. A method as defined in claim 1, wherein the inter-process communication occurs through computer operating system pipes.

3. A method as defined in claim 1, wherein the program execution commands include a pause command that halts execution of the interactive simulation program child process until a wake up program execution command is received.

4. A method as defined in claim 1, wherein the program execution commands include a continue command that continues the execution of the interactive simulation program child process.

5. A method as defined in claim 1, wherein the program execution commands include a command to spawn a child process of the interactive simulation program.

6. A method as defined in claim 1, wherein the program execution commands include a command to advance to a next iteration of a program loop in the program code from which a cycle function call is generated.

7. A method as defined in claim 1, wherein the program execution commands include a command to advance to next multiple iterations of a program loop in the program code from which a cycle function call is generated.

8. A method as defined in claim 1, wherein the simulation control program detects termination of the interactive simulation program child process.

9. A method as defined in claim 1, wherein the simulation control program code detects a signal input received by the interactive simulation program child process from the operating system.

10. A method as defined in claim 9, wherein the signal input comprises an error signal.

11. A method as defined in claim 1, wherein the simulation control program code indicates status of a program execution command as having been successfully or unsuccessfully executed.

12. A method as defined in claim 1, further comprising calling a library function that provides operation to fork a computer process of the interactive simulation program child process and communicate with the forked process through pipes.

13. A method as defined in claim 12, wherein the library function is written in a computer program language other than that of the simulation control program code.

14. A method as defined in claim 1, further comprising:
creating at least one additional child process execution instance of the interactive simulation program;
controlling execution of the additional child process execution instance independently of the interactive simulation program child process through the simulation control program code.

15. A method as defined in claim i, further comprising:
executing the simulation control program code and establishing inter-process communication with the interactive simulation program child process;
receiving a program execution command for the interactive simulation program through a user interface of the simulation control program code;
executing the received program execution command in the child process.

16. A method as defined in claim 15, wherein the user interface comprises a computer input device.

17. A method as defined in claim 16, wherein the computer input device comprises a keyboard.

18. A method as defined in claim 16, wherein the computer input device comprises a computer mouse.

19. A method as defined in claim 15, wherein the received program execution command is received from a script file of predetermined program execution commands.

20. A method as defined in claim 15, wherein the simulation control program code and child process execute within an operating environment embedded within a system that controls operation of a device.

21. A method as defined in claim 15, wherein the simulation control program code provides means for multiple users to interact with the simulation control program code in a single execution instance of the simulation control program code.

22. A method as defined in claim 1, wherein the program execution commands include a gallop command to save a plurality of interactive simulation program states and advance execution of the interactive simulation program through the saved states.

23. A method as defined in claim 22, wherein the interval at which a plurality of interactive simulation program states are saved is determined according to a specified number of iterations of a program loop in the program code from which a cycle function call is generated.

24. A method as defined in claim 22, wherein the interval at which a plurality of interactive simulation program states are saved is determined by one or more events in the simulation program.

25. A method as defined in claim 22, wherein the interval at which a plurality of interactive simulation program states are saved is determined in accordance with computer apparatus clock time.

26. A method as defined in claim 1, wherein a plurality of interactive simulation program states share initial portions of execution which are identical.

27. A method as defined in claim 1, wherein a debugger program can be attached selectively to one or more of multiple saved processes of the interactive simulation program.

28. A method as defined in claim 27, wherein the simulation control program code maintains debugger state information separately for each saved process of the interactive simulation program.

29. A method as defined in claim 28, wherein the debugger state information contains debug context data.

30. A method as defined in claim 27, wherein, when the simulation control program code jumps from one saved process of the interactive simulation program to another saved process, and corresponding saved debugger state information is respectively saved and restored.

31. A method as defined in claim 1, the simulation control program code controls the execution of multiple invocations of any combination of one or more interactive simulation programs.

32. A method as defined in claim 1, wherein the simulation control program code includes program execution commands that provide execution state control at a program instruction level of granularity.

33. A method as defined in claim 1, wherein the simulation control program code comprises a control program that is installed on the computer system and is operated within an operating system of the computer system.

34. A method as defined in claim 1, wherein the simulation control program code is incorporated into program code of an operating system of the computer system.

35. A computer apparatus for execution of a computer program, the computer apparatus comprising:
a processor unit that executes program code;
simulation control program code that can be executed from within an operating system of the computer apparatus, wherein the executing simulation control program code controls execution of an interactive simulation program comprising the computer program code modified with at least one function call inserted in a loop code section of the computer program code, wherein an interactive simulation program child process is in inter-process communication with the executing simulation control program code and wherein the interactive simulation program interactively receives program execution commands from the simulation control program code, such that real-time execution control of the interactive simulation program is achieved with preservation of the computer program behavior.

36. A computer apparatus as defined in claim 35, wherein the inter-process communication occurs through computer operating system pipes.

37. A computer apparatus as defined in claim 35, wherein the program execution commands include a pause command that halts execution of the interactive simulation program child process until a wake up program execution command is received.

38. A computer apparatus as defined in claim 35, wherein the program execution commands include a continue command that continues the execution of the interactive simulation program child process.

39. A computer apparatus as defined in claim 35, wherein the program execution commands include a command to spawn a child process of the interactive simulation program.

40. A computer apparatus as defined in claim 35, wherein the program execution commands include a command to advance to a next iteration of a program loop in the program code from which a cycle function call is generated.

41. A computer apparatus as defined in claim 35, wherein the program execution commands include a command to advance to next multiple iterations of a program loop in the program code from which a cycle function call is generated.

42. A computer apparatus as defined in claim 35, wherein the simulation control program code detects termination of the interactive simulation program child process.

43. A computer apparatus as defined in claim 35, wherein the simulation control program code detects a signal input received by the interactive simulation program child process from the operating system.

44. A computer apparatus as defined in claim 43, wherein the signal input comprises an error signal.

45. A computer apparatus as defined in claim 35, wherein the simulation control program code indicates status of a program execution command as having been successfully or unsuccessfully executed.

46. A computer apparatus as defined in claim 35, further comprising calling a library function that provides operation to fork a computer process of the interactive simulation program child process and communicate with the forked process through pipes.

47. A computer apparatus as defined in claim 46, wherein the library function is written in a computer program language other than that of the simulation control program code.

48. A computer apparatus as defined in claim 35, wherein the apparatus performs operations comprising:
creating at least one additional child process execution instance of the interactive simulation program;
controlling execution of the additional child process execution instance independently of the interactive simulation program child process through the simulation control program code.

49. A computer apparatus as defined in claim 35, wherein the apparatus performs operations comprising:
executing the simulation control program code and establishing inter-process communication with the interactive simulation program child process;
receiving a program execution command for the interactive simulation program through a user interface of the simulation control program code;
executing the received program execution command in the child process.

50. A computer apparatus as defined in claim 49, wherein the user interface comprises a computer input device.

51. A computer apparatus as defined in claim 50, wherein the computer input device comprises a keyboard.

52. A computer apparatus as defined in claim 50, wherein the computer input device comprises a computer mouse.

53. A computer apparatus as defined in claim 49, wherein the received program execution command is received from a script file of predetermined program execution commands.

54. A computer apparatus as defined in claim 49, wherein the simulation control program code and child process execute within an operating environment embedded within a system that controls operation of a device.

55. A computer apparatus as defined in claim 49, wherein the simulation control program code provides means for multiple users to interact with the simulation control program code in a single execution instance of the simulation control program code.

56. A computer apparatus as defined in claim 35, wherein the program execution commands include a gallop command to save a plurality of interactive simulation program states and advance execution of the interactive simulation program through the saved states.

57. A computer apparatus as defined in claim 56, wherein the interval at which a plurality of interactive simulation program states are saved is determined according to a specified number of iterations of a program loop in the program code from which a cycle function call is generated.

58. A computer apparatus as defined in claim 56, wherein the interval at which a plurality of interactive simulation program states are saved is determined by one or more events in the simulation program.

59. A computer apparatus as defined in claim 56, wherein the interval at which a plurality of interactive simulation program states are saved is determined in accordance with computer apparatus clock time.

60. A computer apparatus as defined in claim 35, wherein a plurality of interactive simulation program states share initial portions of execution which are identical.

61. A computer apparatus as defined in claim 35, wherein a debugger program can be attached selectively to one or more of multiple saved processes of the interactive simulation program.

62. A computer apparatus as defined in claim 61, wherein the simulation control program code maintains debugger state information separately for each saved process of the interactive simulation program.

63. A computer apparatus as defined in claim 62, wherein the debugger state information includes debug context data.

64. A computer apparatus as defined in claim 61, wherein, when the simulation control program code jumps from one saved process of the interactive simulation program state to another saved process, and corresponding saved debugger state information is respectively saved and restored.

65. A computer apparatus as defined in claim 35, the simulation control program code controls the execution of multiple invocations of any combination of one or more interactive simulation programs.

66. A computer apparatus as defined in claim 35, wherein the simulation control program code includes program execution commands that provide execution state control at a program instruction level of granularity.

67. A computer apparatus as defined in claim 35, wherein the simulation control program code comprises a control program that is installed on the computer system and is operated within an operating system of the computer system.

68. A computer apparatus as defined in claim 35, wherein the simulation control program code is incorporated into program code of an operating system of the computer system.

69. A program product for use in a computer system that executes program steps recorded in a computer-readable media to perform a method for executing a computer program, the program product comprising:
a recordable media;
a program of computer-readable instructions executable by the computer system to perform operations comprising:
executing simulation control program code from within an operating system of the computer apparatus;
controlling execution of an interactive simulation program comprising the computer program code modified with at least one function call inserted in a loop code section of the computer program code;
wherein an interactive simulation program child process is in inter-process communication with the executing simulation control program code and wherein the interactive simulation program interactively receives program execution commands from the simulation control program code, such that real-time execution control of the interactive simulation program is achieved with preservation of the computer program behavior.

70. A program product as defined in claim 69, wherein the inter-process communication occurs through computer operating system pipes.

71. A program product as defined in claim 69, wherein the program execution commands include a pause command that halts execution of the interactive simulation program child process until a wake up program execution command is received.

72. A program product as defined in claim 69, wherein the program execution commands include a continue command that continues the execution of the interactive simulation program child process.

73. A program product as defined in claim 69, wherein the program execution commands include a command to spawn a child process of the interactive simulation program.

74. A program product as defined in claim 69, wherein the program execution commands include a command to advance to a next iteration of a program loop in the program code from which a cycle function call is generated.

75. A program product as defined in claim 69, wherein the program execution commands include a command to advance to next multiple iterations of a program loop in the program code from which a cycle function call is generated.

76. A program product as defined in claim 69, wherein the simulation control program detects termination of the interactive simulation program child process.

77. A program product as defined in claim 69, wherein the simulation control program code detects a signal input received by the interactive simulation program child process from the operating system.

78. A program product as defined in claim 77, wherein the signal input comprises an error signal.

79. A program product as defined in claim 69, wherein the simulation control program code indicates status of a program execution command as having been successfully or unsuccessfully executed.

80. A program product as defined in claim 69, further comprising calling a library function that provides operation to fork a computer process of the interactive simulation program child process and communicate with the forked process through pipes.

81. A program product as defined in claim 80, wherein the library function is written in a computer program language other than that of the simulation control program code.

82. A program product as defined in claim 69, further comprising:
creating at least one additional child process execution instance of the interactive simulation program;
controlling execution of the additional child process execution instance independently of the interactive simulation program child process through the simulation control program code.

83. A program product as defined in claim 69, further comprising:
executing the simulation control program code and establishing inter-process communication with the interactive simulation program child process;
receiving a program execution command for the interactive simulation program through a user interface of the simulation control program code;
executing the received program execution command in the child process.

84. A program product as defined in claim 83, wherein the user interface comprises a computer input device.

85. A program product as defined in claim 84, wherein the computer input device comprises a keyboard.

86. A program product as defined in claim 84, wherein the computer input device comprises a computer mouse.

87. A program product as defined in claim 83, wherein the received program execution command is received from a script file of predetermined program execution commands.

88. A program product as defined in claim 83, wherein the simulation control program code and child process execute within an operating environment embedded within a system that controls operation of a device.

89. A program product as defined in claim 83, wherein the simulation control program code provides means for multiple users to interact with the simulation control program code in a single execution instance of the simulation control program code.

90. A program product as defined in claim 69, wherein the program execution commands include a gallop command to save a plurality of interactive simulation program states and advance execution of the interactive simulation program through the saved states.

91. A program product as defined in claim 90, wherein the interval at which a plurality of interactive simulation program states are saved is determined according to a specified number of iterations of a program loop in the program code from which a cycle function call is generated.

92. A program product as defined in claim 90, wherein the interval at which a plurality of interactive simulation program states are saved is determined by one or more events in the simulation program.

93. A program product as defined in claim 90, wherein the interval at which a plurality of interactive simulation program states are saved is determined in accordance with computer apparatus clock time.

94. A program product as defined in claim 69, wherein a plurality of interactive simulation program states share initial portions of execution which are identical.

95. A program product as defined in claim 69, wherein a debugger program can be attached selectively to one or more of multiple saved processes of the interactive simulation program.

96. A program product as defined in claim 95, wherein the simulation control program code maintains debugger state information separately for each-saved process of the interactive simulation program.

97. A program product as defined in claim 96, wherein the debugger state information includes debug context data.

98. A program product as defined in claim 95, wherein, when the simulation control program code jumps from one saved process of the interactive simulation program to another saved process, and corresponding saved debugger state information is respectively saved and restored.

99. A program product as defined in claim 69, the simulation control program code controls the execution of multiple invocations of any combination of one or more interactive simulation programs.

100. A program product as defined in claim 69, wherein the simulation control program code includes program execution commands that provide execution state control at a program instruction level of granularity.

101. A program product as defined in claim 69, wherein the simulation control program code comprises a control program that is installed on the computer system and is operated within an operating system of the computer system.

102. A program product as defined in claim 69, wherein the simulation control program code is incorporated into program code of an operating system of the computer system.
